(19) United States
(12) Patent Application Publication
(10) Pub. No.: US 2020/0095859 A1
(43) Pub. Date: Mar. 26, 2020

(54) Bit-Rock Interaction Modeling

(71) Applicant: Halliburton Energy Services, Inc., Houston, TX (US)

(72) Inventor: Shilin Chen, Montgomery, TX (US)

(73) Assignee: Halliburton Energy Services, Inc., Houston, TX (US)

(21) Appl. No.: 16/618,685

(22) PCT Filed: Jul. 7, 2017
(86) PCT No.: PCT/US2017/041158

§ 371 Date: Dec. 2, 2019

(51) Int. Cl. E21B 44/04; E21B 7/04; E21B 10/42; E21B 10/567; G05B 17/02

(52) U.S. Cl. CPC E21B 44/04; E21B 7/04; G05B 17/02; E21B 10/567; E21B 10/42

(57) ABSTRACT

A method for bit-rock interaction modeling includes selecting a parameter for a drill bit model. The parameter includes a geometrical factor of a cutter represented in the drill bit model. The method further includes dynamically adjusting the drill bit model to a displaced position, updating a shape of a wellbore model formed by the displaced position of the drill bit model, and determining local and initial forces on the drill bit model based on the shape of the wellbore model and the parameter for the drill bit model. The method further includes determining, by a processor, at least one coefficient for a bit matrix based on the local force and the initial force on the drill bit model; and storing the bit matrix in a memory, wherein the bit matrix is indicative of an interaction between a drill bit represented by the drill bit model and a formation substrate.

### BACKGROUND

### Field

The exemplary embodiments described herein relate to drill bits and their use in oil and gas exploration and production. More particularly, one or more embodiments disclosed herein relate to methods of modelling and operating polycrystalline diamond compact (PDC) bits having a desired steer-ability for use in drilling operations.

### Description of the Related Art

Various types of downhole drilling tools including, but not limited to, rotary drill bits, reamers, core bits, and other downhole tools have been used to form wellbores in associated downhole formations. Examples of such rotary drill bits include, but are not limited to, fixed cutter drill bits, drag bits, PDC drill bits, and matrix drill bits associated with forming oil and gas wells extending through one or more downhole formations.

In oil and gas production and exploration, wellbore drilling may extend several kilometers underground. The process is time consuming and involves high operation costs, therefore demanding high reliability and reducing down-hole time for the drilling tools. In current field applications (e.g., directional drilling, high angle drilling, extended reach, and horizontal drilling), wellbores may include multiple portions or legs, each extending not only vertically, but at an angle from each other, or even horizontally relative to the surface. State-of-the-art drilling configurations face severe penalties for drilling delays (e.g., drill replacement) or errors. Many drilling operations can encounter a stuck pipe, a side track, a lost drill string, or a broken drill bit, as a result of drilling malfunction. Other events encountered in drilling operations can include over-crookedness (“dogleg”) of the wellbore, or an over-gaged hole, which increases overall costs in drilling fluid, pumping, setting casing, cementing, and potential plugging of the well. Other effects that are desirably avoided during drilling include wavy profiles in well trajectory (e.g., “drill walk”), which cause greatly increased torque and drag, potentially damaging a drill string.

### BRIEF DESCRIPTION OF THE DRAWINGS

The following figures are included to illustrate certain aspects of the exemplary embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a wellbore formed by a downhole drilling tool, according to one or more embodiments.

FIG. 2A illustrates a drill bit including cutters, according to some embodiments.

FIG. 2B illustrates movement of a drill bit with respect to a hole coordinate system, according to some embodiments.

FIG. 3A illustrates a side view of a cutter for a drill bit, according to some embodiments.

FIG. 3B illustrates a front view of a cutter for a drill bit, according to some embodiments.

FIG. 3C illustrates an x-y-z coordinate system with Z being the axis of the bit or of the hole, according to some embodiments.

FIG. 3D illustrates a radial-drag-z coordinate system, according to some embodiments.

FIG. 3E illustrates a side view of a cutter for a drill bit, including a back rake angle, according to some embodiments.

FIG. 3F illustrates a side view of a cutter for a drill bit, including a side rake angle, according to some embodiments.

FIG. 3G illustrates a profile view of a drill bit, including a cutter at a profile angle, according to some embodiments.

FIG. 4A illustrates a perspective view of a mesh, including cutlets in a cutter, according to some embodiments.

FIG. 4B illustrates a dynamic mesh, including cutlets in a cutter at two different times, according to some embodiments.

FIG. 4C illustrates a dynamic mesh, including cutlets in a cutter at two different times, according to some embodiments.

FIG. 5 illustrates a side view of a cutting face in a cutter engaging a formation substrate, according to some embodiments.

FIG. 6 illustrates a plan view of a cutting face in a cutter engaging a formation substrate, according to some embodiments.

FIG. 7 illustrates a flowchart including steps in a method for determining a shape and a size of a chip portion of a formation formed after engagement with a cutter, according to some embodiments.

FIG. 8 illustrates a perspective view of a cutter engaging a portion of a formation substrate, according to some embodiments.

FIG. 9 illustrates a perspective view of a gage cutter for a drill bit, according to some embodiments.

FIG. 10A illustrates a plane view of a mesh including cutlets in a gage pad for determining rock-interaction forces with the formation substrate, according to some embodiments.

FIG. 10B illustrates a side view of a mesh including cutlets in a gage pad for determining rock-interaction forces with the formation substrate, according to some embodiments.

FIG. 11A illustrates a contact area in a first shape in a bit-rock interaction, according to some embodiments.

FIG. 11B illustrates a contact area in a second shape in a bit-rock interaction, according to some embodiments.

FIG. 11C illustrates a contact area in a third shape in a bit-rock interaction, according to some embodiments.

FIG. 12 illustrates a flowchart including steps in a method for modeling a bit-rock interaction, according to some embodiments.

FIG. 13 illustrates a flowchart including steps in a method for determining a steer force and a walk force on a drill bit, according to some embodiments.

FIG. 14 is a block diagram illustrating an example computer system with which the methods of FIGS. 7, 12 and 13 can be implemented.

### DETAILED DESCRIPTION

The exemplary embodiments described herein relate to methods and systems for determining bit matrices that represent bit-rock interaction to improve design and performance of drill bits in the oil and gas industry. Some of the bit matrices may include bit matrices associating local forces on the drill bit with a velocity or a displacement of the drill bit. Some of the bit matrices may include nonlinear matrices associating local forces on the drill bit with a velocity or a displacement of the drill bit. In some embodiments, the drill bit includes a PDC bit, which provides a reliable and durable drilling performance. Fixed cutter drill bits such as PDC bits may include multiple blades that each includes multiple cutting elements.

In typical drilling applications, a PDC bit may be used to drill through various levels or types of geological formations with longer bit life than non-PDC bits. Typical formations may generally have a relatively low compressive strength in the upper portions (e.g., lesser drilling depths) of the formation and a relatively high compressive strength in the lower portions (e.g., greater drilling depths) of the formation. Thus, it becomes gradually more difficult to drill at increasingly greater depths. In general, the ideal conditions for a drill bit (e.g., rotation speed, steering angle, and the like) at any particular depth are typically a function of the compressive strength of the formation at that depth. Accordingly, ideal drill bit conditions typically change as a function of drilling depth. A drilling tool may include one or more depth of cut controllers (DOCCs) configured to control the amount that a drilling tool cuts into the side of a geological formation. However, conventional DOCC configurations may cause an uneven depth of cut control of the cutting elements of the drilling tool. This uneven depth of cut control may cause portions of the DOCCs to wear unevenly. Also, uneven depth of cut control may cause the drilling tool to vibrate excessively, which may damage parts of the drill string or slow the drilling process.

Some embodiments as disclosed herein provide improved design and performance modeling of drill bits having good azimuthal control and steer-ability, particularly over horizontal sections. Further, some embodiments provide improved design and performance modeling of anti-walk drill bits that mitigate the walk, or drift phenomenon.

In some embodiments, bit-rock interaction models as described herein may be included in the design and fabrication of reliable drill bits. Moreover, embodiments as disclosed herein may be used in drilling operations to estimate forces on the drill bit and a drilling efficiency, in real time. Some embodiments as disclosed herein may be used to predict bit-drilling direction, including bit steer and walk direction, in real time. Some embodiments as disclosed herein may be used in real-time bottomhole assembly (BHA) dynamic simulations. Some embodiments as disclosed herein may be used in BHA models for drilling automation.

Some embodiments of methods and systems as disclosed herein may be used to gather data from drilling operations and improve drill bit design to make the drilling process more efficient. For example, drill bits may be designed to be more steerable, to use less drilling fluid, and to form more uniform wellbores.

In some embodiments, methods as disclosed herein increase the speed of computer simulation of the drilling process by using bit matrices representing bit-rock interaction. Methods as disclosed herein substantially improve the performance of a computer used drilling system modeling because the use of bit matrices to represent bit-rock interaction, thus reducing cost in power and processing time of the computer modelling.

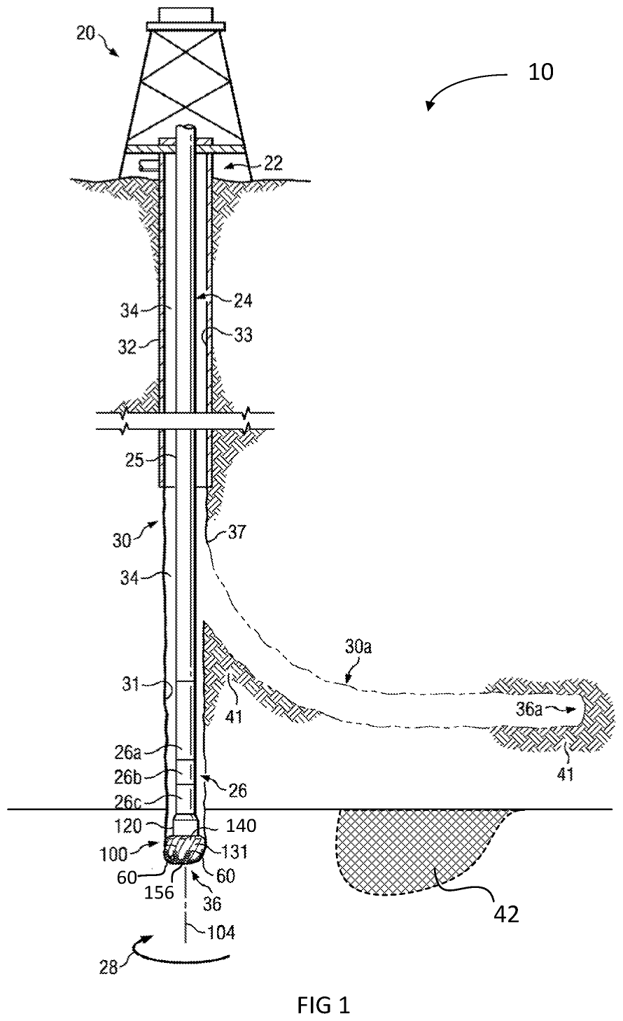

FIG. 1 illustrates an example embodiment of a drilling system 10 configured to drill into one or more geological formations, in accordance with some embodiments of the present disclosure. While drilling into different types of geological formations, it may be advantageous to control the amount that a downhole drilling tool cuts into the side of a geological formation in order to reduce wear on the cutting elements of the drilling tool, prevent uneven cutting into the formation, increase control of penetration rate, reduce tool vibration, etc. As disclosed in further detail below, drilling system 10 may include downhole drilling tools (e.g., a drill bit, a reamer, a hole opener, etc.) that may include one or more cutting elements with a depth of cut that may be controlled by one or more depth of cut controllers (DOCC).

Drilling system 10 includes wellbores 30 and 30a formed by a downhole drilling tool, according to one or more embodiments. A drill bit represented by drill bit model 100 may be designed and manufactured in accordance with embodiments disclosed herein by selecting locations for laying out cutter 60 on different zones (locations or segments) of a bit face profile in relation to a spiral direction of bit rotation 28 about bit rotational axis 104. In some embodiments, drill bit model 100 may be further designed and manufactured in accordance with teachings of the present disclosure to substantially reduce and/or minimize imbalance forces, which may result from contact between drill bit model 100 and downhole end 36 of wellbore 30 or downhole end 36a of horizontal wellbore 30a, including one or multiple downhole formations as may be seen in transitional drilling. Various aspects of the present disclosure may be described with respect to drilling rig 20, drill string 24 and attached drill bit model 100. Cutter 60, according to the present disclosure, may be disposed at selected locations on exterior portions of blades 131, to substantially reduce bit axial force, bit torque and bit imbalance forces of drill bit model 100 during uniform downhole drilling, non-uniform downhole drilling conditions and/or transition drilling conditions.

Bit imbalance forces may cause vibration of drill string 24 when drill bit model 100 initially contacts downhole end 36 of wellbore 30 or downhole end 36a of horizontal wellbore 30a. Such vibration may extend from drill bit model 100 throughout the length of drill string 24. Imbalance forces acting on a downhole drilling tool may also result during transition drilling from a first generally soft formation layer into a second, generally harder downhole formation layer. Imbalance forces acting on a downhole drilling tool may also result from drilling from a first downhole formation into a second downhole formation where the second downhole formation may be tilted at an angle other than normal to a wellbore formed by a downhole drilling tool.

Wellbores 30 and/or 30a may often extend through one or more different types of downhole formation materials or formation layers. A drill bit represented by drill bit model 100 may be used to extend wellbore 30 through a first formation layer 41 and into second formation layer 42. For some applications, first formation layer 41 may have a compressive strength or hardness less than the compressive strength or hardness of second formation layer 42. During transition drilling between first formation layer 41 and second (harder) formation layer 42, significant imbalance forces may be applied to a downhole drill tool resulting in an undesired vibration of an associated downhole drill string.

Various types of drilling equipment such as a rotary table, mud pumps and mud tanks (not expressly shown) may be located at well surface or well site 22. Drilling rig 20 may have various characteristics and features associated with a “land drilling rig”. However, downhole drilling tools incorporating teachings of the present disclosure may be satisfactorily used with drilling equipment located on offshore platforms, drill ships, semi-submersibles and drilling barges (not expressly shown).

BHA 26 may be formed from a wide variety of components. For example, components 26a, 26b and 26c may include, but not limited to, drill collars, rotary steering tools, directional drilling tools and/or downhole drilling motors. The number of components such as drill collars and different types of components included in a BHA will depend upon anticipated downhole drilling conditions and the type of wellbore that will be formed by drill string 24 and rotary drill bit model 100.

Drill string 24 and drill bit model 100 may be used to form a wide variety of wellbores and/or bore holes such as a generally vertical wellbore 30 and/or generally horizontal wellbore 30a. Various directional drilling techniques and associated components of BHA 26 may be used to form horizontal wellbore 30a. For example, lateral forces may be applied to drill bit model 100 proximate kickoff location 37 to form horizontal wellbore 30a extending from generally vertical wellbore 30. Excessive amounts of vibration or imbalance forces applied to a drill string while forming a directional wellbore may cause significant problems with steering drill string and/or damage one or more downhole components. Such vibration may be particularly undesirable during formation of horizontal wellbore 30a. Designing and manufacturing rotary drill bit model 100 and/or other downhole drilling tools by selecting locations for laying out cutter 60 on different zones (locations) of a bit face profile in relation to a spiral direction of bit rotation about bit rotational axis 104 and in some embodiments further using multilevel force balancing techniques incorporating teachings of the present disclosure may substantially enhance stability and steerability of rotary drill bit model 100 and other downhole drilling tools.

Wellbore 30 defined in part by casing string 32 may extend from well surface 22 to a selected downhole location. Portions of wellbore 30 that do not include casing string 32 may be described as “open hole.” Various types of drilling fluid may be pumped from well surface 22 through drill string 24 to attached rotary drill bit model 100. Such drilling fluids may be directed to flow from drill string 24 to respective nozzles 156 provided in rotary drill bit model 100.

The drilling fluid may be circulated back to well surface 22 through annulus 34 defined in part by outside diameter 25 of drill string 24 and inside diameter 31 of wellbore 30. Inside diameter 31 may also be referred to as the “sidewall” of wellbore 30. Annulus 34 may also be defined by outside diameter 25 of drill string 24 and inside diameter 33 of casing string 32. Drilling fluids may also flow through junk slots 140 that are disposed between two adjacent blades on a drill bit.

Rate of penetration (ROP) of a rotary drill bit is often a function of both weight on bit (WOB) and revolutions per minute (RPM). For example, it is reasonable to expect that a higher rate of RPM will be associated with a higher ROP over the same formation substrate. Drill string 24 may apply weight on drill bit model 100 and also rotate drill bit model 100 to form wellbore 30. For some applications a downhole motor (not expressly shown) may be provided as part of BHA 26 to also rotate rotary drill bit model 100.

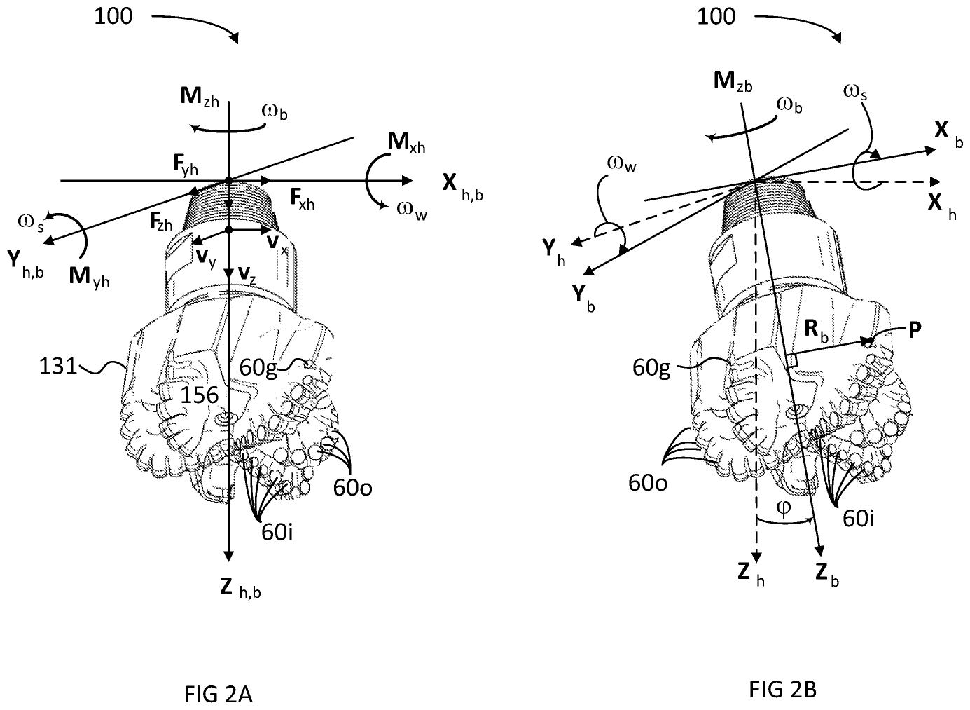

FIG. 2A illustrates a drill bit model 100 including cutters 60i, 60o, and 60g (hereinafter collectively referred to as “cutters 60”) on blades 131, according to some embodiments. Drill bit model 100 may represent a drill bit for use in a drilling operation, as disclosed herein. In some embodiments cutters 60 and other downhole drilling tools may be designed according to the various portions of the profile of a drill bit represented by the drill bit model 100 in relation to the wellbore. For example, cutters 60 are distributed in zones on the profile of drill bit model 100 as outer cutters 60o, placed in an outer zone; inner cutters 60i, placed in an inner zone, and gage cutters 60g (e.g., also referred to as “drop-in” element) placed on gage zone. Other types of cutters not illustrated may include “nose cutters,” placed in a nose zone of drill bit model 100, “shoulder cutters” placed in a shoulder zone of drill bit model 100, “cone cutters,” placed in a cone zone of drill bit model 100, and “transit cutters,” placed in a transit zone of drill bit model 100. In some embodiments, it is convenient to define two coordinate systems. The first coordinate system is a hole coordinate system, Xₕ Yₕ Zₕ. In the hole coordinate system, the depth, Zₕ, may initially coincide with a bit axis Z_{b}. A second coordinate system is a bit coordinate system, X_{b} Y_{b} Z_{b}, which is fixed with the body of drill bit model 100 and rotates with the bit around its Z_{b} axis. Generally speaking, drill bit model 100 has 6 degrees of freedom, defined in hole coordinate system, Xₕ Yₕ Zₕ, and illustrated in FIG. 2A:
{x, y, z, θₓ, θ_{y}, θ_{z}}

There are 6 associated local forces, also defined in hole coordinate system, Xₕ, Yₕ, Zₕ:
Fₕ={Fₓₕ, F_{yh}, F_{zh}, Mₓₕ, M_{yh}, M_{zh}}

There are also 6 associated local forces, defined in bit coordinate system, X_{b} Y_{b} Z_{b}:
F_{b}={F_{xb}, F_{yb}, F_{zb}, M_{xb}, M_{yb}, M_{zb}}

FIG. 2B illustrates movement of drill bit model 100 with respect to the hole coordinate system {Xₕ, Yₕ, Zₕ}, according to some embodiments. The movement in FIG. 2B is along an azimuthal angle, φ, formed between the axes Zₕ and Z_{b} of hole and bit coordinate systems, respectively. Point P may be located on the cutting face of 60g, at a radial distance R_{b} from drill axis Z_{b}.

During drilling, rock is removed by rotating drill bit model 100 around its axis, Z_{b}. However, in some embodiments rotation alone is not sufficient to move the drill bit ahead and form the wellbore (e.g., along axis Zₕ). Therefore, bit rotation around its axis (Z_{b}) is not an independent variable. If we use depth of cut per bit revolution (in/rev), (simply called depth of cut), a displacement of drill bit model 100 may be fully determined by at least some independent variables, such as: Axial depth of cut, vz, (in/rev), which is defined as: v_{z}=ROP/5 RPM; Lateral depth of cut, vx, (in/rev), which is defined as: vₓ=ROX/5 RPM; Lateral depth of cut, v_{y}, (in/rev), which is defined as: v_{y}=ROY/5 RPM; Rotational degree around Xₕ, ωₓ (deg/rev); and rotational degree around Yₕ, ω_{y} (deg/rev)

v_{Z}=ROP/5 RPM

vₓ=ROX/5 RPM

v_{y}=ROY/5 RPM

vᵣ=\sqrt{vₓ²+v_{y}²}

ωₓ=60·\dot{θ}ₓ/RPM

ω_{y}=60·\dot{θ}_{y}/RPM

ωᵣ=\sqrt{ωₓ²+ω_{y}²} (1)

Where \dot{θ}ₓ is rotational speed around Xₕ (deg/sec), and \dot{θ}_{y} is rotational speed around Yₕ (deg/sec).

Without loss of generality, the set of velocity values in Eq. 1 may be referred to as a “drill bit velocity configuration,” v={vₓ, v_{y}, v_{z}, ωₓ, ω_{y}}. The motion of a point P on the bit body can be determined by the “drill bit velocity configuration.” In some embodiments, BHA 26 (cf. FIG. 1) operates in a “push-the-bit” steerable configuration, pushing drill bit model 100 in any of the three directions Xₕ, Yₕ, Zₕ, while the bit is rotating about its axis (Z_{b}). A push-the-bit embodiment therefore including the three linear velocities of drill bit model 100, namely, v={vₓ, v_{y}, v_{z}} as drilling parameters acting on drill bit model 100. Accordingly, a bit-rock interaction in such embodiments includes a relation between the motion of drill bit model 100 (e.g., v) and the local forces exerted on drill bit model 100 (e.g., Fₕ) may be represented by the following matrix equation in hole coordinate system:

$$\{ \begin{matrix}{F}_{xh} \\ {F}_{yh} \\ {F}_{zh} \\ {M}_{xh} \\ {M}_{yh} \\ {M}_{zh}\end{matrix} \} = [ \begin{matrix}{C}_{11} & {C}_{12} & {C}_{13} \\ {C}_{21} & {C}_{22} & {C}_{23} \\ {C}_{31} & {C}_{32} & {C}_{33} \\ {C}_{41} & {C}_{42} & {C}_{43} \\ {C}_{51} & {C}_{52} & {C}_{53} \\ {C}_{61} & {C}_{62} & {C}_{63}\end{matrix} ] \{ \begin{matrix}{v}_{x} \\ {v}_{y} \\ {v}_{z}\end{matrix} \} + \{ \begin{matrix}{F}_{xo} \\ {F}_{yo} \\ {F}_{zo} \\ {M}_{xo} \\ {M}_{yo} \\ {M}_{zo}\end{matrix} \} \qquad ( 2 )$$

wherein elements Cᵢⱼ with i=1, 2, 3, 4, 5, 6, and j=1, 2, 3, are damping coefficients collectively referred to as bit matrix C. In some embodiments, it may be seen that bit matrix C is not a square matrix, it has dimension 6×3.

Equation 2 includes 6 local forces (outputs), and 3 parameter inputs (e.g., v). The initial force vector, Fₒ={Fₓₒ F_{yo} F_{zo} Mₓₒ M_{yo}, M_{zo}}, is related to a wear condition of drill bit model 100. More specifically, the initial force vector Fₒ may be associated with a chamfer of the cutting edge of cutter 60 (e.g., an inherent radius of curvature in the sharp edges of the cutter). In order for drill bit model 100 to start penetrating the formation substrate and forming the wellbore, the applied local force, F, may be equal to or greater than the initial force, Fₒ. For a new drill bit model 100 including sharp cutters, initial force vector Fₒ may become zero, or approximately zero. Under these conditions, it is expected that the wellbore is formed (F 0) as soon as drill bit model 100 starts moving (v 0).

Matrix C and the associated initial force vector, Fₒ, may be called “bit matrices” which represent bit-rock interaction.

In some embodiments, BHA 26 (cf. FIG. 1) operates in a “point-the-bit” steerable configuration providing axial and tilting motions to drill bit model 100, in addition to vertical penetration (e.g., along axis Z_{b}). Accordingly, a steerable system may include axial penetration, walk rate, and build rate, {v_{z}, ω_{w}, ωₛ}, respectively, as drilling parameters acting on drill bit model 100, a bit-rock interaction may be represented by the following matrix equation in hole coordinate system:

$$\{ \begin{matrix}{F}_{xh} \\ {F}_{yh} \\ {F}_{zh} \\ {M}_{xh} \\ {M}_{yh} \\ {M}_{zh}\end{matrix} \} = [ \begin{matrix}{ɛ}_{11} & {ɛ}_{12} & {ɛ}_{13} \\ {ɛ}_{21} & {ɛ}_{22} & {ɛ}_{23} \\ {ɛ}_{31} & {ɛ}_{32} & {ɛ}_{33} \\ {ɛ}_{41} & {ɛ}_{42} & {ɛ}_{43} \\ {ɛ}_{51} & {ɛ}_{52} & {ɛ}_{53} \\ {ɛ}_{61} & {ɛ}_{62} & {ɛ}_{63}\end{matrix} ] \{ \begin{matrix}{v}_{z} \\ {ω}_{w} \\ {ω}_{s}\end{matrix} \} + \{ \begin{matrix}{F}_{xo} \\ {F}_{yo} \\ {F}_{zo} \\ {M}_{xo} \\ {M}_{yo} \\ {M}_{zo}\end{matrix} \} \qquad ( 3 )$$

elements εᵢⱼ, with i=1, 2, 3, 4, 5, 6, and j=1, 2, 3, are damping coefficients collectively referred to as bit matrix s.

Similarly to bit matrix C, bit matrix s is not a square matrix and has dimension 6×3. As in Eq. 2, there are 6 local forces (outputs), and 3 parameter inputs in Eq. 3. One or more of the matrix s and the associated initial force vector, Fₒ, may be referred to as “bit matrices” which represent bit-rock interaction.

In a more general configuration, BHA 26 moves drill bit model 100 with respect to the hole coordinate system based on five (5) drilling parameters, namely: three linear velocities, {vₓ, v_{y}, v_{z}} and two rotational velocities, {ω_{w}, ωₛ}. This may be the case, for example, of a hybrid steerable system combining “push-the-bit” and “point-the-bit” configurations. Accordingly, a bit-rock interaction may be represented by the following matrix equation in hole coordinate system:

$$\{ \begin{matrix}{F}_{xh} \\ {F}_{yh} \\ {F}_{zh} \\ {M}_{xh} \\ {M}_{yh} \\ {M}_{zh}\end{matrix} \} = [ \begin{matrix}{λ}_{11} & {λ}_{12} & {λ}_{13} & {λ}_{14} & {λ}_{15} \\ {λ}_{21} & {λ}_{22} & {λ}_{23} & {λ}_{24} & {λ}_{25} \\ {λ}_{31} & {λ}_{32} & {λ}_{33} & {λ}_{34} & {λ}_{35} \\ {λ}_{41} & {λ}_{42} & {λ}_{43} & {λ}_{44} & {λ}_{45} \\ {λ}_{51} & {λ}_{52} & {λ}_{53} & {λ}_{54} & {λ}_{55} \\ {λ}_{61} & {λ}_{62} & {λ}_{63} & {λ}_{64} & {λ}_{65}\end{matrix} ] \{ \begin{matrix}{v}_{x} \\ {v}_{y} \\ {v}_{z} \\ {ω}_{w} \\ {ω}_{s}\end{matrix} \} + \{ \begin{matrix}{F}_{xo} \\ {F}_{yo} \\ {F}_{zo} \\ {M}_{xo} \\ {M}_{yo} \\ {M}_{zo}\end{matrix} \} \qquad ( 4 )$$

elements λᵢⱼ, with i=1, 2, 3, 4, 5, 6, and j=1, 2, 3, 4, 5, are damping coefficients that may be collectively referred to as bit matrix, λ.

Similarly to bit matrices C and ε, λ is not a square matrix, but has dimension 6×5. Likewise to Eqs. 2 and 3, there are more outputs (6 local forces), than parameter inputs in Eq. 9 (e.g., 5 parameter inputs). Matrix λ and the associated initial force vector, Fₒ, may be called “bit matrices” which represent bit-rock interaction. Moreover, with the values for bit matrix C and for Fₒ, in equation (2), a weight on bit (WOB) and a torque on bit (TOB) can be determined,

WOB=F_{zh}=C₃₃v_{z}+F_{zo}

TOB=M_{zh}=C₆₃v_{z}+M_{zo}, (5)

wherein C₃₃ may be associated with how fast drill bit model 100 can drill. Furthermore, in some embodiments a ratio may be obtained,

$$\frac{{C}_{63}}{{C}_{33}} = \frac{TOB - {M}_{zo}}{WOB - {F}_{zo}} \qquad ( 6 )$$

this ratio may indicate a drilling efficiency of drill bit model 100. The ratio in Eq. 6 expresses the ability of drill bit model 100 to dig into the hole “depth” (F_{zh}), at a reduced torque on the rotational axis (M_{zh}).

A steer force (Fₛ), a walk force (F_{w}), and a bit axial force (Fₐ) may be obtained from Eq. 2 as

Fₛ=Fₓₕ=C₁₁·vₓ+C₁₃·v_{z}+Fₓₒ

F_{w}=F_{yh}=C₂₁·vₓ+C₂₃·v_{z}+F_{yo}

Fₐ=F_{zh}=C₃₁·vₓ+C₃₃·v_{z}+F_{zo} (7)

In some embodiments, the steer force, Fₛ, and the walk force, F_{w}, may be affected by v_{z} only slightly, so that it may be assumed that C₁₃, C₂₃, and C₃₁ are sufficiently negligible. When the initial contact force is zero (Fₓₒ=F_{yo}=F_{zo}=0), a total lateral force Fi may be determined as

Fₗ=\sqrt{Fₓ²+F_{w}²}=\sqrt{C₁₁²+C₂₁²}·vₓ

Fₐ=C₃₃·v_{z} (8)

In some embodiments, a side cutting ability of the drill bit may be determined using an expression such as

$$η = \frac{{v}_{x} / Fl}{{v}_{z} / Fa} = \frac{{C}_{33}}{\sqrt{{C}_{11}^{2} + {C}_{21}^{2}}} \qquad ( 9 )$$

In some embodiments, a “walk” angle, α, for the drill bit, may be determined as

α=a tan(C₂₁/C₁₁) (10)

In some embodiments, a general bit-rock interaction (cf. Eq. 4) may be described as

$$\begin{matrix} ( 11 ) \\ \{ \begin{matrix}Fx \\ Fy \\ Fz \\ Mx \\ My \\ Mz\end{matrix} \} = \{ \begin{matrix}{F}_{xh} \\ {F}_{yh} \\ {F}_{zh} \\ {M}_{xh} \\ {M}_{yh} \\ {M}_{zh}\end{matrix} \} - \{ \begin{matrix}{F}_{xo} \\ {F}_{yo} \\ {F}_{zo} \\ {M}_{xo} \\ {M}_{yo} \\ {M}_{zo}\end{matrix} \} = [ \begin{matrix}{λ}_{11} & {λ}_{12} & {λ}_{13} & {λ}_{14} & {λ}_{15} & 0 \\ {λ}_{21} & {λ}_{22} & {λ}_{23} & {λ}_{24} & {λ}_{25} & 0 \\ {λ}_{31} & {λ}_{32} & {λ}_{33} & {λ}_{34} & {λ}_{35} & 0 \\ {λ}_{41} & {λ}_{42} & {λ}_{43} & {λ}_{44} & {λ}_{45} & 0 \\ {λ}_{51} & {λ}_{52} & {λ}_{53} & {λ}_{54} & {λ}_{55} & 0 \\ {λ}_{61} & {λ}_{62} & {λ}_{63} & {λ}_{64} & {λ}_{65} & 1\end{matrix} ] \cdot \{ \begin{matrix}{v}_{x} \\ {v}_{y} \\ {v}_{z} \\ {ω}_{w} \\ {ω}_{s} \\ 0\end{matrix} \}\end{matrix}$$

In some embodiments, Eq. 11 may be further simplified to

$$\{ \begin{matrix}Fx \\ Fy \\ Fz \\ Mx \\ My \\ Mz\end{matrix} \} == [ λ ] \cdot \{ \begin{matrix}{v}_{x} \\ {v}_{y} \\ {v}_{z} \\ {ω}_{w} \\ {ω}_{s} \\ 0\end{matrix} \} \qquad ( 12 )$$

where bit matrix, [λ], is a square matrix that may be included into a general BHA dynamic model to represent bit-rock interaction. Equations 2 to equation 12 used linear matrices to represent bit-rock interaction. In some embodiments, nonlinear matrices may be more accurate. Linear equations may be written in a more simple form: The nonlinear matrices may be generally written in the following form:

{F}=[Hₙ]{V}ⁿ+[Hₙ₋₁]{V}ⁿ⁻¹+ . . . +[H₁]{V}+{F₀} (13)

Eq. 13 represents a non-linear bit-rock interaction, where V=(vₓ, v_{y}, v_{z}, ωₓ, ω_{y}), and V^{k}={vₓ^{k}, v_{y}^{k}, v_{z}^{k}, wₓ^{k}, ω_{y}^{k}}, for k=2, . . . , n.

In order to simplify the calculation of the elements of matrices, [Hᵢ], in Eq. 13, consider a special case where v={vᵣ, ωᵣ, v_{z}}. In this way, the lateral motions in x and y directions are simplified to a radial motion. Similarly, the two rotations around x and y are simplified to a radial rotation. In this case, bit matrices [Hᵢ] in Eq. 13 are reduced to a dimension 6×3.

The linear form in the radial coordinate system may be rewritten:

$$\{ \begin{matrix}{F}_{dh} \\ {F}_{rh} \\ {F}_{zh} \\ {M}_{dh} \\ {M}_{rh} \\ {M}_{zh}\end{matrix} \} = [ \begin{matrix}{h}_{11} & {h}_{12} & {h}_{13} \\ {h}_{21} & {h}_{22} & {h}_{23} \\ {h}_{31} & {h}_{32} & {h}_{33} \\ {h}_{41} & {h}_{42} & {h}_{43} \\ {h}_{51} & {h}_{52} & {h}_{53} \\ {h}_{61} & {h}_{62} & {h}_{63}\end{matrix} ] \{ \begin{matrix}{v}_{r} \\ {ω}_{r} \\ {v}_{z}\end{matrix} \} + \{ \begin{matrix}{F}_{do} \\ {F}_{ro} \\ {F}_{zo} \\ {M}_{do} \\ {M}_{ro} \\ {M}_{zo}\end{matrix} \} \qquad ( 14 )$$

As an example, elements in matrix h of Eq. 14 may be calculated by the following steps: Let v_{z}≠0, and vᵣ=0, or ωᵣ=0, we have

F_{zh}=h₃₃v_{z}+F_{zo} (15.1)

M_{z}=h₆₃v_{z}+M_{zo} (15.2)

By choosing at least two different values for v_{z}, coefficients in Eq. 15.1 can be obtained by a one degree of polynomial curve fitting, h₃₃ is the 1^{st} coefficients and F_{zo} is the 2^{nd} coefficients of the polynomial. Similarly, coefficients h₆₃ and M_{zo} in Eq. 15.2 can be solved by another one degree of polynomial curve fitting. Variable v_{z} may be divided into several ranges, so Eqs. 15.1 and 15.2 may be solved for each range, respectively. For example, for a bit designed for soft formation drilling, v_{z} may be within 0.1-0.5 in/rev. On the other hand, for a bit designed for hard formation drilling, v_{z} may be within 0.01-0.1 in/rev.

Some embodiments may include a configuration wherein: vᵣ≠0, and ωᵣ=0, v_{z}=0; accordingly, Eq. 14 becomes the following set of six equations,

F_{dh}=h₁₁vᵣ+F_{do} (16.1)

M_{dh}=h₄₁vᵣ+M_{do} (16.2)

Fᵣₕ=h₂₁vᵣ+Fᵣₒ (16.3)

Mᵣₕ=h₅₁vᵣ+Mᵣₒ (16.4)

F_{zh}=h₃₁vᵣ+F_{zo} (16.5)

M_{zh}=h₆₁vᵣ+M_{zo} (16.6)

Selecting at least two different values of vᵣ, and using one order of polynomial curve fitting to each equation, coefficients in equation (16): h₁₁, F_{do}, h₄₁, M_{do}, h₂₁, Fᵣₒ, h₅₁, Mᵣₒ, h₃₁, h₆₁. Variable vᵣ may be divided into several ranges, so Eq. 16 may be solved for each range. For example, for a bit designed for a wellbore with small DLS (Dogleg Severity, deg/100 ft), then vᵣ may be in the range of 0.0001-0.001 in/rev.

Yet further embodiments may include a configuration wherein ωᵣ≠0, and vᵣ=0, v_{z}=0, accordingly, Eq. 14 becomes the following set of six equations,

Fᵣₕ=h₂₂ωᵣ+Fᵣₒ (17.1)

Mᵣₕ=h₅₂ωᵣ+Mᵣₒ (17.2)

F_{dh}=h₁₂ωᵣ+F_{do} (17.3)

M_{dh}=h₄₂ωᵣ+M_{do} (17.4)

F_{zh}=h₃₂ωᵣ+F_{zo} (17.5)

M_{zh}=h₅₂ωᵣ+M_{zo} (17.6)

Selecting at least two different values of ωᵣ, and using one order of polynomial curve fitting to each equation, coefficients in Eq. 17, h₂₂, Fᵣₒ, h₅₂, Mᵣₒ, h₁₂, F_{do}, h₄₂, and M_{do}. In some embodiments variable ωr may be divided into several ranges. For example, for a bit designed for a well with small DLS (0-5 deg/100 ft), ωᵣ is usually in the range of 0.0001˜0.001 deg/rev. For a bit designed for a well with large DLS (10-20 deg/100 ft), ωᵣ is usually in the range of 0.001˜0.005 deg/rev. Accordingly, Eq. 18 may be solved for each range.

A further embodiment may include a configuration wherein vᵣ≠0, v_{z}≠0, ωᵣ=0, accordingly, Eqs. 15-17 become the following set of two equations,

F_{dh}=h₁₁vᵣ+h₁₃v_{z}+F_{do} (18.1)

M_{dh}=h₄₁vᵣ+h₄₃v_{z}+M_{do} (18.2)

Selecting at least two different values of v_{z} and/or vᵣ, and using h₁₁, h₄₁ and F_{do} and M_{do} obtained from Eqs. 15 and 16, Eqs. 18 may be solved to determine the unknowns h₁₃ and h₄₃. Selecting v_{z} and/or vᵣ within a range, a least-squares regression line may be obtained to solve for h₁₃ and h₄₃, including error estimates. Variables v_{z} and/or vᵣ may be divided into several ranges as described in detail above, so Eqs. 18 may be solved for each range.

Some embodiments may include a configuration where ωᵣ≠0, v_{z}≠0, vᵣ=0, resulting in:

Fᵣₕ=h₂₂ωᵣ+h₂₃v_{z}+Fᵣₒ (19.1)

Mᵣₕ=h₅₂ωᵣ+h₅₃v_{z}+M_{do} (19.2)

Selecting values for v_{z} and/or ωᵣ, we may solve Eqs. 19 for h₂₃ and h₅₃. In some embodiments, changing v_{z} and/or ωᵣ within a range, a least-squares regression line may be obtained and h₂₃ and h₅₃ may be solved including error estimates for each unknown. Variables v_{z} and/or ωᵣ may be divided into several penetration rate and rotating rate ranges as discussed in detail above, and Eqs. 19 may be solved for each range.

Accordingly, embodiments of bit-rock interaction models as disclosed herein provide values for the elements in matrix H and initial force vector {Fxo, Fyo, Fzo, Mxo, Myo, Mzo} in Eq. 13, including error estimates for at least some of the unknowns.

Forces in radial-drag-z coordinate can be transformed into xyz coordinate:

$$\begin{matrix} ( 20 ) \\ \{ \begin{matrix}{F}_{xh} \\ {F}_{yh} \\ {F}_{zh} \\ {M}_{xh} \\ {M}_{yh} \\ {M}_{zh}\end{matrix} \} = [ \begin{matrix}cos ( a ) & - sin ( a ) & 0 & 0 & 0 & 0 \\ sin ( a ) & cos ( a ) & 0 & 0 & 0 & 0 \\ 0 & 0 & 1 & 0 & 0 & 0 \\ 0 & 0 & 0 & cos ( b ) & - sin ( b ) & 0 \\ 0 & 0 & 0 & sin ( b ) & cos ( b ) & 0 \\ 0 & 0 & 0 & 0 & 0 & 1\end{matrix} ] \cdot \{ \begin{matrix}{F}_{dh} \\ {F}_{rh} \\ {F}_{zh} \\ {M}_{dh} \\ {M}_{rh} \\ {M}_{zh}\end{matrix} \}\end{matrix}$$

With “a” and “b” defined as

$$a = {tan}^{- 1} \frac{{v}_{y}}{{v}_{x}} ; b = {tan}^{- 1} \frac{{ω}_{x}}{{ω}_{y}} .$$

Eqs. 13 and 20 provide a complete solution for the linear portion of Eq. 13 (e.g., H₁). The model in Eq. 13 represents bit-rock interactions for any given bit steady-state motion, v={vₓ, v_{y}, v_{z}, ωₓ, ω_{y}}).

If an n-order polynomial is used in all the procedures above, then the nonlinear matrices in Eq. 13 can be similarly solved. For example, let n=3. In the radial-drag-z coordinate, let v_{z}≠0, and vᵣ=0, ωᵣ=0, we have

F_{zh}=h_{3,33}v_{z}³+h_{2,33}v_{z}²+h_{1,33}v_{z}¹+F_{z0} (21.1)

M_{zh}=h_{3,63}v_{z}³+h_{2,63}v_{z}²+h_{1,63}v_{z}¹+M_{z0} (21.2)

By choosing at least five (5) different values for v_{z} as inputs to the bit-rock interaction model (DxD), two data sets {v_{z},F_{zh}} and {v_{z},M_{zh}} are obtained. Coefficients in Eq. 21.1 can be obtained by a third degree of polynomial curve fitting of {v_{z},F_{zh}}, h_{3,33} is the 1^{st} coefficients, h_{2,33} is the 2^{nd} coefficients, h_{1,33} is the 3^{rd} coefficients, and F_{zo} is the 4^{th} coefficients of the polynomial. Similarly, coefficients h_{3,63}, h_{2,63}, h_{1,63} and M_{zo} in Eq. 21.2 can be solved by another three degree of polynomial curve fitting of {v_{z},M_{zh}}.

Simply replacing one degree of polynomial curve fitting with n degree of polynomial curve fitting in the steps a) to e), all matrices [Hᵢ], i=1, n, including the initial bit forces, in Eq. 13 can be obtained. Forces in radial-drag-z coordinate is obtained for any given bit motion in radial-drag-z coordinate system.

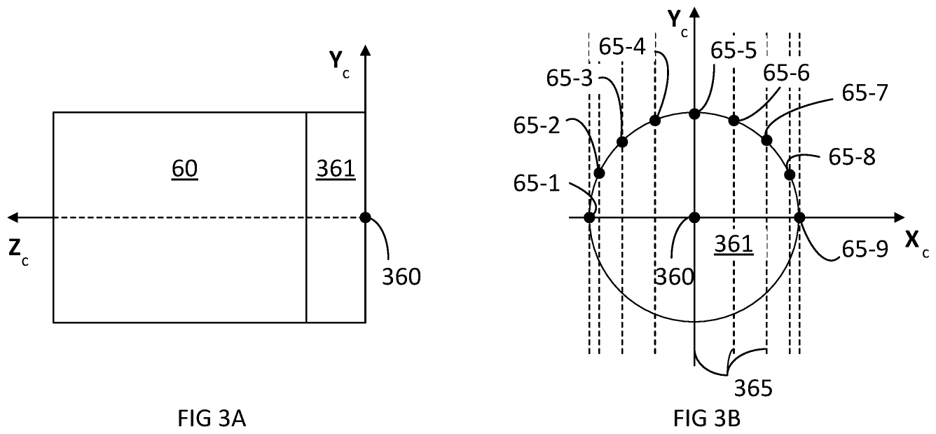

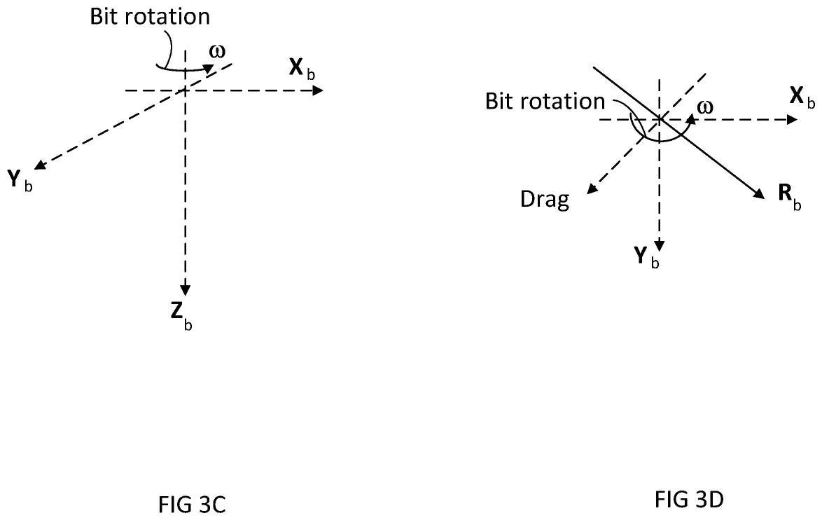

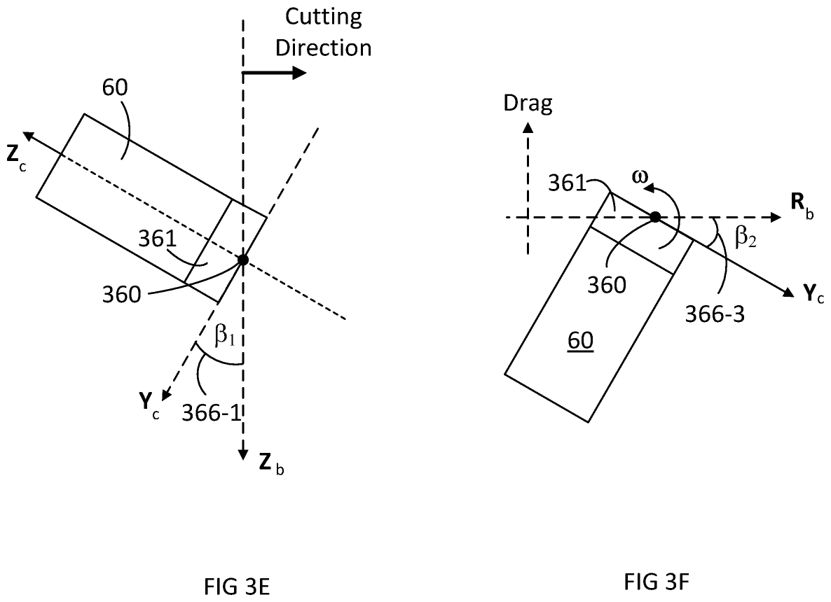

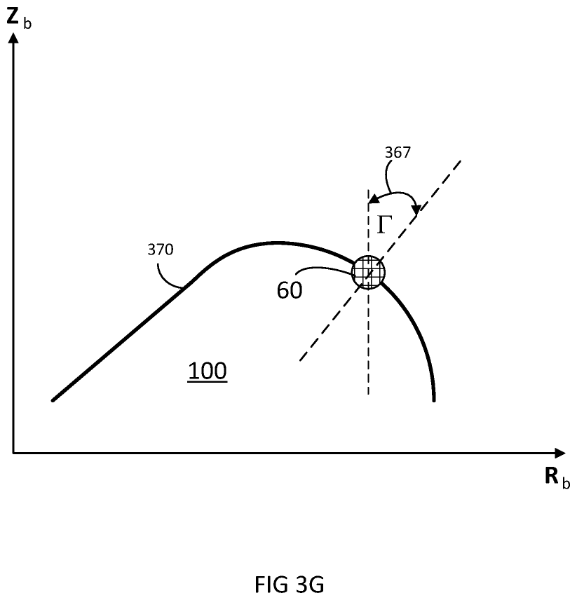

Once elements in all matrices of Eq. 13 are obtained in radial-drag-z coordinate, a coordinate transformation, (e.g., Eq. 20) may be also used for the nonlinear model to get the force vector Fₕ={Fₓₕ, F_{yh}, F_{zh}, Mₓₕ, M_{yh}, M_{zh}}. The above steps may be executed either by experimentation or by numerical models. Accordingly, embodiments as disclosed herein include determining the local force, Fₕ, on a drill bit resulting from a specific drill bit velocity configuration, vₕ or v and using Eqs 2-21 to represent a bit-rock interaction model (e.g., solving for the components of any of bit matrices C, ε, λ, H3, H2, H1). In some embodiments, the local force, Fₕ, is determined from direct measurement under different drill bit velocity configurations, vₕ. In some embodiments, the local forces, Fₕ, are obtained from a numerical model that includes the drill bit velocity configuration, vₕ, as will be shown in FIGS. 3-12, below.

In some embodiments, a calibration step may be included to the bit-rock interaction model, when cutter forces are proportional to rock strength. Therefore, during all the above calculations, we can assume the rock strength σ=1 (pounds per square inch, psi). When the saved bit-matrices are used to calculate bit forces, a factor of rock strength σ must be multiplied.

{F_{f}}=kσ{Fₘ} (22)

Where Fₘ is the calculated force vector from bit-matrices and F_{f} is the final bit force. Factor k is called a calibration factor. If, for a specific bit, its WOB, ROP, RPM and σ are known, then factor k can be calculated as

$$k = \frac{Measured WOB}{Calculated WOB} \qquad ( 23 )$$

In some embodiments, a bit-rock interaction model as disclosed herein may be used to improve or adjust a drill bit design. In some embodiments a drill bit model representing a drill bit is already created, and a bit-rock interaction model as disclosed herein generates a bit matrix for the drill bit by using the drill bit model to create a wellbore model (e.g., a cut out of substrate formation material forming a borehole), as will be described in detail in FIGS. 3A-B through 12, below. Accordingly, a BHA may incorporate the generated bit matrix in the memory, the BHA being further configured to drive the drill bit to form a wellbore in real-time. The BHA may also be configured to incorporate the specific characteristics of a substrate formation using Eqs. 22 and 23, above, according to a drilling location.

FIG. 3A illustrates a side view of a cutter 60 for a drill bit model 100, according to some embodiments. Axes Xc, Yc, and Zc are a local coordinate axis system anchored on cutter 60, with origin 360 fixed at the center of cutter 60. Facing the negative side of axis Zc, a cutting face 361 includes a layer of PDC to interact with and fracture the formation.

FIG. 3B illustrates a front view of cutter 60 for drill bit model 100, according to some embodiments. Cutting face 361 is divided in a grid 365 into cutlets 65-1 through 65-9 (hereinafter, collectively referred to as cutlets 65). Cutlets 65 are cutting points geometrically defined by grid 365 along a cutting edge of cutter 60, and having cutlet coordinates {x_{c}, y_{c}, z_{c}} in the cutter local coordinate axis system.

FIG. 3C illustrates an x-y-z coordinate system with Z being the axis of the bit or of the hole. FIG. 3D illustrates a radial-drag-z coordinate system. FIG. 3E illustrates a side view of cutter 60 for drill bit model 100 including back rake angle 366-1 (β₁). FIG. 3F illustrates a plan view of cutter 60 for drill bit model 100 including side rake angle 366-3 (β₂), according to some embodiments. FIG. 3G illustrates a radial plan view of bit profile 370 for drill bit model 100 including a profile angle 367 (Γ).

In some embodiments, a bit-rock interaction model as disclosed herein may be used to adjust bit design parameters such as back rake angle 366-1 (β₁), side rake angle 366-3 (β₂) and profile angle 367 (Γ) of at least one or more cutters 60 in the drill bit. The modifications to the bit design parameters may be directed to increase drilling efficiency (amount of formation substrate cut away to form the wellbore over a given period of time), to increase bit steerability, or to reduce force imbalance on the drill bit, and bit torque that may induce DLS in the wellbore.

In general, cutlet coordinates {x_{c}, y_{c}, z_{c}}ᵢ indicating the position of cutlet 65-i may be transformed into a bit coordinate system X_{b}, Y_{b}, Z_{b} fixed on drill bit model 100 to render cutlet coordinates {x_{b}, y_{b}, Z_{b}}ᵢ

$${\{ \begin{matrix}{x}_{b} \\ {y}_{b} \\ {z}_{b}\end{matrix} \}}_{i} = [ {T}_{bc} ] \cdot {\{ \begin{matrix}{x}_{c} \\ {y}_{c} \\ {z}_{c}\end{matrix} \}}_{i} + \{ \begin{matrix}{o}_{cx} \\ {o}_{cy} \\ {o}_{cz}\end{matrix} \} \qquad ( 24 )$$

where T_{bc} is a transformation matrix from the cutter local coordinate axis system to the bit coordinate system, and {o_{cx}, o_{cy}, o_{cz}} is the location of the cutter center, e.g. origin 360, in the bit coordinate system.

Elements in matrix T_{b}c are dependent on back rake angle 366-1, and side rake angle 366-3. Note also that back rake angle 366-1, and side rake angle 366-3 are design parameters for drill bit model 100 and may be chosen according to desired specifications.

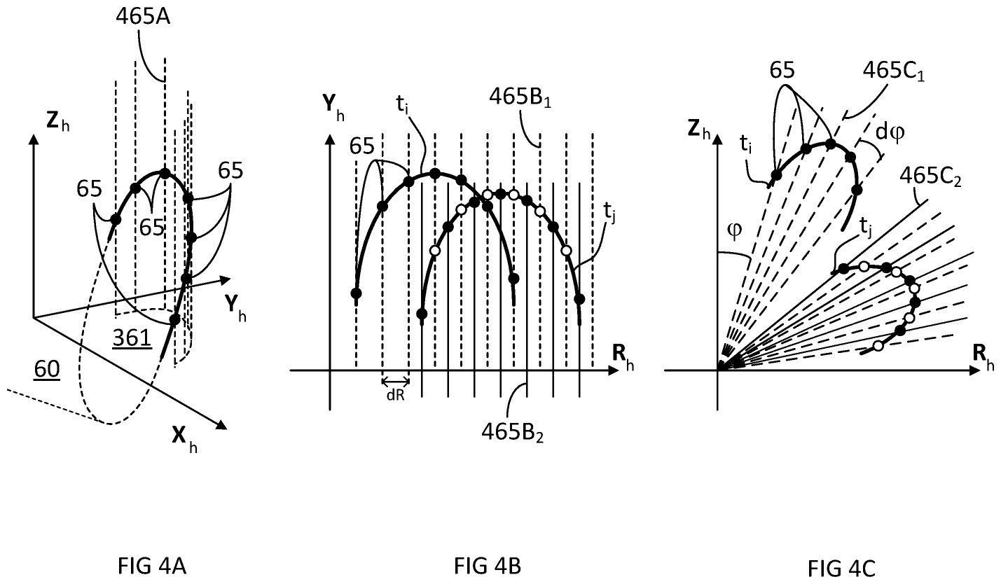

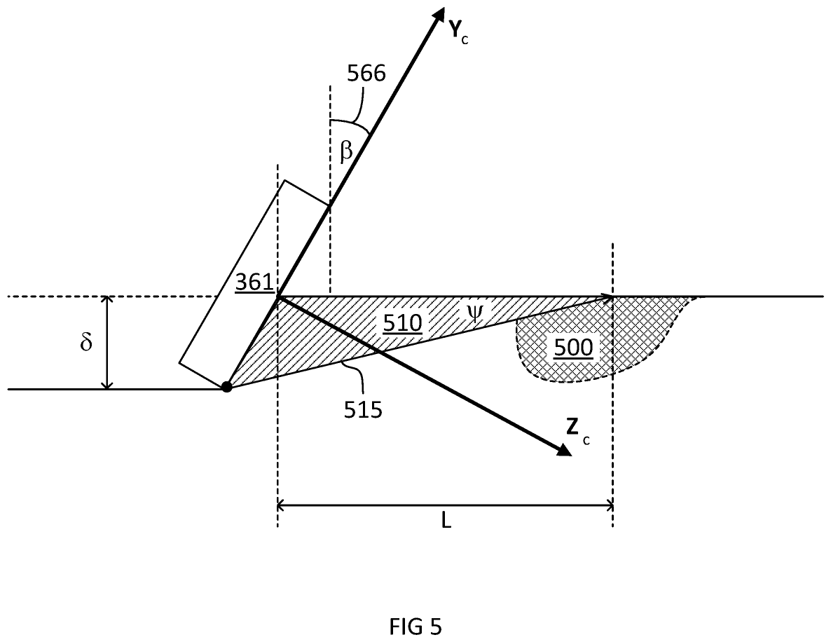

FIG. 4A illustrates a perspective view of a mesh 465A including cutlets 65 in the cutting face 361 of cutter 60, according to some embodiments. Mesh 465A is described in reference to hole coordinate system Xₕ, Yₕ, Zₕ. Note that cutlets 65 form part of cutting face 361 and therefore may be contained in the same plane. In some embodiments, even when cutlets 65 form part of cutting face 361, they may be arranged in a non-coplanar fashion, for example when cutting face 361 has a cutout, or an angled portion. As cutter 60 moves about hole coordinate system Xₕ, Yₕ, Zₕ, while drill bit model 100 is displaced for cutting, cutlets 65 change their position and mesh 465A should be updated for each time interval increment, dt.

FIG. 4B illustrates a dynamic mesh 465B₁ including cutlets 65 in cutter 60 at two different times, tᵢ, and tⱼ, (e.g., t=tᵢ+dt) according to some embodiments (cutter 60 is omitted from the figure, for clarity). Different coordinate systems may be preferable for a better cinematic description of cutter 60 within the hole. In a polar coordinate system, axis Rₕ shows the radial distance of cutter 60 to hole axis (Zₕ) at each time step, cutlets 65 are re-meshed so that the radial location of cutlets 65 is an integer number of intervals dR. Accordingly, in some embodiments all, or almost all cutlets 65 are re-meshed for all, or almost all cutters in drill bit model 100, for each time interval increment, dt.

FIG. 4C illustrates a dynamic mesh 465C₁ including cutlets 65 in cutter 60 at two different times tᵢ, and tⱼ, (e.g., t=tᵢ+dt), according to some embodiments (cutter 60 is omitted from the figure, for clarity). Mesh 465C₁ is defined in spherical coordinates, as this may be more easily manageable to describe the rotation of the drill bit about the hole axis (Zₕ). In spherical coordinate system, at each time interval increment, dt, cutlets 65 are re-meshed into dynamic 465C₂ so that the φ angle of each cutlet 65 is an integer number of intervals, dφ. In some embodiments all, or almost all cutlets 65 are re-meshed for all, or almost all cutters 60 in drill bit model 100, for each time interval increment, dt.

In some embodiments, the re-meshing of cutlet coordinates described above in relation to FIGS. 4A-C enables the accurate tracking of each of cutlets 65 and its interaction with the formation substrate, as drill bit model 100 is displaced in the wellbore. Note that, in some embodiments, the re-meshing includes accounting for changes in velocity (linear and angular, cf. Eq. 1) of drill bit model 100.

FIG. 5 illustrates a side view of cutting face 361 in a cutter engaging a formation substrate 500, according to some embodiments. Accordingly, in embodiments consistent with the present disclosure drill bit model 100 is modeled to cut away a portion 510 of formation substrate 500 to form a wellbore model. In this side view, the back rake angle (β) defines the “attack” angle of cutting face 361 onto formation substrate 500. Crack trajectory 515 may be simplified to a straight line as shown so that only depth of cut, δ, and angle, γ, are used. Angle ψ may be calculated from a knowledge of the cutting depth δ and of rake angle 566. In some embodiments, substrate portions 510 chipped away during a cutter test in the lab may be collected and the dimensions (e.g., L and δ), may be measured. Angle ψ may be thus be calculated as, ψ=arctan (δ/L). In some embodiments, rock chips or cuttings may be collected during drill operations to measure their size and update the bit-rock interaction model.

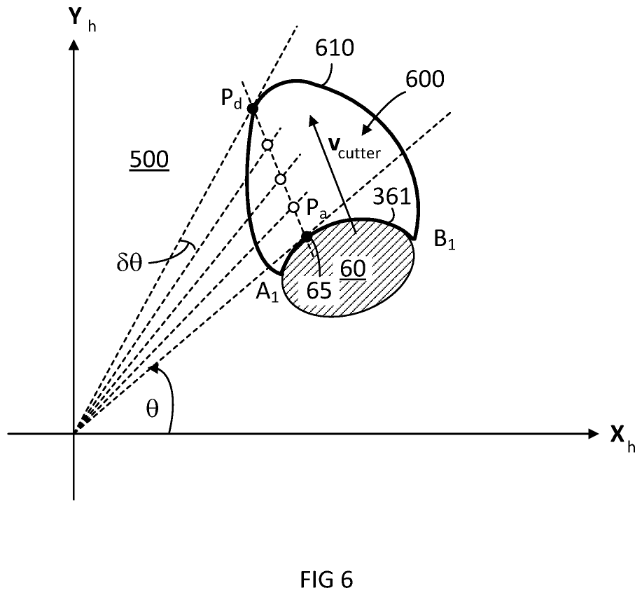

FIG. 6 illustrates a plan view of cutting face 361 of cutter 60 engaging formation substrate 500, according to some embodiments. As a result, a formation portion 600 is chipped away from formation substrate 500. Formation portion 600 includes a boundary line 610 contained within the Xₕ, Yₕ plane (i.e., Zₕ=0, or approximately zero, for points in boundary line 610). Cutter 60 is moving in the plane Xₕ, Yₕ along the direction indicated as v_{cutter}. Note that, in general, even when cutting face 361 is planar, the profile it makes on plane Xₕ, Yₕ may be curved. A single cutlet 65, Pₐ, in cutter 60 is highlighted for illustrative purposes.

In some embodiments, boundary line 610 including curve A₁-P_{d}-B₁ is obtained by determining the length, L, of segment Pₐ-P_{d} (cf. FIG. 5) for each of cutlets 65 in cutter 60. The direction of segment Pₐ-P_{d} is selected from the direction of vector, v_{cutter}, at time, t. In some embodiments, a three-dimensional (3D) model of formation portion 600 is obtained from boundary line 610 and the knowledge of the depth of cut, SPa, of cutlet Pₐ, for each cutlet 65, along segment A₁-Pₐ-B₁. For example, in some embodiments a linear function may be assumed for the depth, Zₕ, of the 3D model of formation portion 600 between points Pₐ (Zₕ=−δPₐ) and P_{d} (Zₕ=0). In some embodiments, the 3D model of formation portion 600 is removed from the bottom of the wellbore once it is formed. Thus, Zₕ coordinates for points on the bottom of the wellbore within boundary line 610 may be updated.

The use of the bottom hole in FIG. 6 and the choice of coordinate plane Xₕ, Yₕ and the cutting depth, d, along the Zₕ axis is arbitrary and for illustrative purposes only. According to the above description, cutter 60 may be inner cutter 60i barreling through the bottom of the wellbore. In some embodiments, a similar description may be used for a formation portion 600 chipped away by outer cutter 60o or gage cutter 60g on the side (or “wall”) of the wellbore, according to the hole coordinate system {Xₕ, Yₕ, Zₕ}.

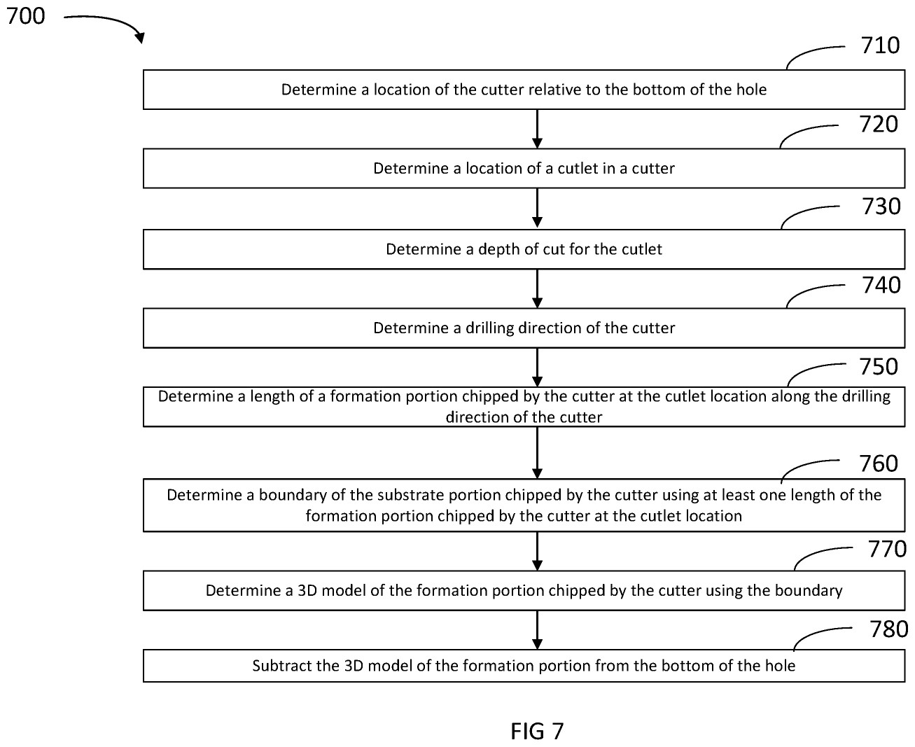

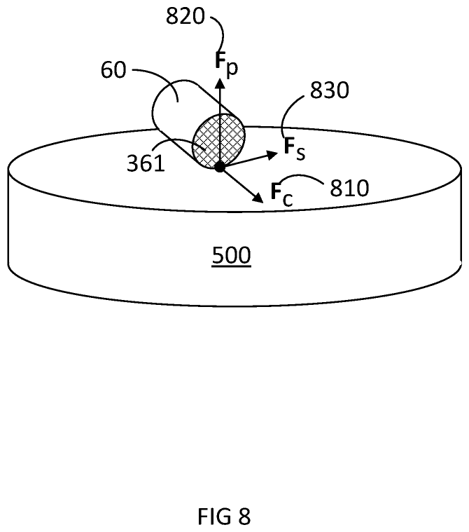

FIG. 7 illustrates a flowchart including steps in a method 700 for determining a shape and a size of a formation portion chipped away after engagement with a cutter from a drill bit, according to some embodiments (e.g., formation portion 600, cutter 60, and drill bit model 100). Accordingly, method 700 includes updating a shape of the wellbore model cut out by drill bit model 100, so that a bit matrix may be determined for use in real-time operations to control and steer a drill bit manufactured based on drill bit model 100. The cutter in method 700 may include one or more cutlets along an edge of a cutting face (e.g., cutlets 65 and cutting face 361). More specifically, method 700 may include determining a 3D model for a formation portion chipped in a bit-rock interaction model as disclosed herein.

Method 700 may be performed at least partially by a computer system including a processor and a memory. At least some of the steps in method 700 may be performed by a computer having a processor executing commands stored in a memory of the computer. Further, steps as disclosed in method 700 may include retrieving, editing, and/or storing files in a database that is part of, or is communicably coupled to, the computer, using, inter-alia, a network communications module. The database may include any one of formation substrate data, computer-aided design data files (e.g., 3D models of drill bit model 100 and components, and/or wellbore 30) and the like. Methods consistent with the present disclosure may include at least some, but not all of the steps illustrated in method 700, performed in a different sequence. Furthermore, methods consistent with the present disclosure may include at least two or more steps as in method 700 performed overlapping in time, or almost simultaneously.

Step 710 includes determining a location of the cutter relative to the formation substrate. Without loss of generality, and for illustrative purposes only, the cutter may be an inner cutter (e.g., inner cutter 60i), and the formation substrate may be at the bottom of the hole. In some embodiments, step 710 includes defining a formation point, Pf, at the bottom of the hole in cylindrical coordinates (Rₕ, θₕ, and Zₕ) and dividing the bottom of the hole in cylindrical segments dR and dθ (e.g., dθ˜1 deg. and dR˜0.001 inches). A cutlet in the drill bit may be represented by a point, P, having coordinates (R_{c}, θ_{c}, and Z_{c}).

Step 720 includes determining a location of the cutlet in the cutter, at time t. Step 730 includes determining a depth of cut, δp1, for the cutlet. In some embodiments, step 730 includes determining δp1 as

δp1=Z_{c}−Zₕ (25)

where Z_{c} is the “depth” of the cutter, and Zₕ is the depth of the hole at point Pf

Step 740 includes determining the drilling direction at time t. In some embodiments, step 740 includes determining the direction of motion of the cutter at time t. For example, step 740 may determine that the cutter is moving radially around axis Zₕ, along a circumference of radius R_{c}. In some embodiments, step 740 includes determining that the cutter is moving in a direction forming an arbitrary angle with respect to the circumference of radius R_{c}.

Step 750 includes determining a length, L, of a formation portion chipped by the cutter 60 along the drilling direction. In some embodiments, when the depth of cut, δp1, is larger than a critical depth, step 750 includes determining the length as

L=δp1/tan ψ (26)

When δp1 is smaller than the critical depth, then step 750 may include selecting L=0.

Step 760 includes determining a boundary of the substrate portion chipped by the cutter using at least one length of the formation portion chipped by the cutlet (e.g., L). In some embodiments, the boundary is determined by selecting a section of length L along the drilling direction. As mentioned above, in some embodiments the drilling direction is along a circumference of radius R_{c}, in which case the boundary of the substrate portion will have a radius Rₐ=R_{c}. In some embodiments, the drilling direction forms an arbitrary angle with the circumference of radius R_{c}, in which case the boundary of the substrate portion will have a radius Rₐ different from R_{c} (e.g., Rₐ≤R_{c}, or Rₐ≥R_{c}).

Step 770 includes determining a 3D model of the formation portion chipped by the cutter using the boundary of the substrate portion. Accordingly, step 770 may include repeating steps 730 through 760 for all cutlets in the cutter, as defined in a dynamic mesh at time t to obtain a two-dimensional profile of the formation portion. In addition, step 770 may include determining a formation portion height, δb, for each point in the formation portion chipped away by the drill bit. Formation portion height δb may be obtained using statistical data for the size and shape of previously measured formation portions. In some embodiments, formation portion height δb is obtained assuming that the formation portion has a wedge shape (e.g., with a linear slope) having a height, δb=δp1, on the cutlet side and a height, δb=0, on the boundary side.

The 3D model of the formation portion can be similarly integrated into the bit-rock interaction model when a spherical coordinate system is used. Accordingly, embodiments of a bit-rock interaction model as disclosed herein may represent a drill bit that interacts with a substrate formation to form a wellbore. Further, in some embodiments, a bit-rock interaction model as disclosed herein, may include modelling at least portions of a wellbore formed with a drill bit. Moreover, in some embodiments, a bit-rock interaction model may provide a bit matrix and an initial force vector that represent the bit-rock interaction in a simplified manner, rather than rely on a complex and time-consuming 3D model. Accordingly, a bit matrix obtained as in embodiments disclosed herein enables a fast processing of drilling configurations so as to guide a drill bit in real-time, e.g. while drilling, using less computational resources than a full bit-rock interaction model, thereby enabling the system to adjust to varying drilling conditions and react more quickly to unexpected formation characteristics.

Step 780 includes subtracting the 3D model of the formation portion chipped by the cutter from the bottom of the hole. In some embodiments, step 780 includes obtaining a point P₁ for the cutlet in the hole reference frame (e.g., polar coordinates Rₚ₁, θₚ₁ in frame Rₕ, θₕ, Zₕ) and a point P₂ (e.g., Rₚ₂, θₚ₂) on the boundary of the formation portion, wherein point P₂ is separated from point P₁ by the distance, L, along the cutter's direction of motion at time t (cf. points Pₐ and P_{d} in FIG. 6). Further, step 780 may include selecting “n” points Pⱼ (where n is 2 or greater, and j≤n), evenly spaced along a linear segment of length, L, joining P₁ and P₂. For each point, Pⱼ, having coordinates (Rⱼ, θⱼ, Zⱼ), step 780 may include updating a matrix Z_{bottom} of hole bottom depth values as follows:

Z_{bottom}(Rⱼ,θⱼ)=Zⱼ−δP₁(j−1)/(n−1) (j=1 . . . n) (27)

where δP₁ is the cutting depth at position P₁ (cf. step 730). Without loss of generality, it may be assumed that Rⱼ=Rₚ₁ (in general, Rⱼ and θⱼ may be derived from Rₚ₁ and the cutter's direction of motion at time t). Without loss of generality, in Eq. 27, the coordinates (polar, Cartesian, and the like) are defined in the hole coordinate system.

More generally, step 780 includes renewing the drill bit height according to the subtracted formation portion, for example using the equation

Z₂new(Pf)=Z₂old(Pf)−δb (28)

where δb is the chip height as determined in step 770. Accordingly, step 780 may include integrating Eq. 28 over all points Pf at the bottom of the hole.

The steps in method 700 have been described above for a cutter in the interior portion (e.g., cutter 60i) of the drill bit, such that the formation portion chipped away increases the “depth,” Zₕ, of the wellbore. More generally, methods consistent with method 700 may include formation portions chipped away from any one of outer cutters or gage cutters in a drill bit. The analysis may be somewhat altered in terms of the coordinates used to describe the 3D shape of the formation portion, relative to a hole coordinate frame, but the steps are naturally derived from the above description.

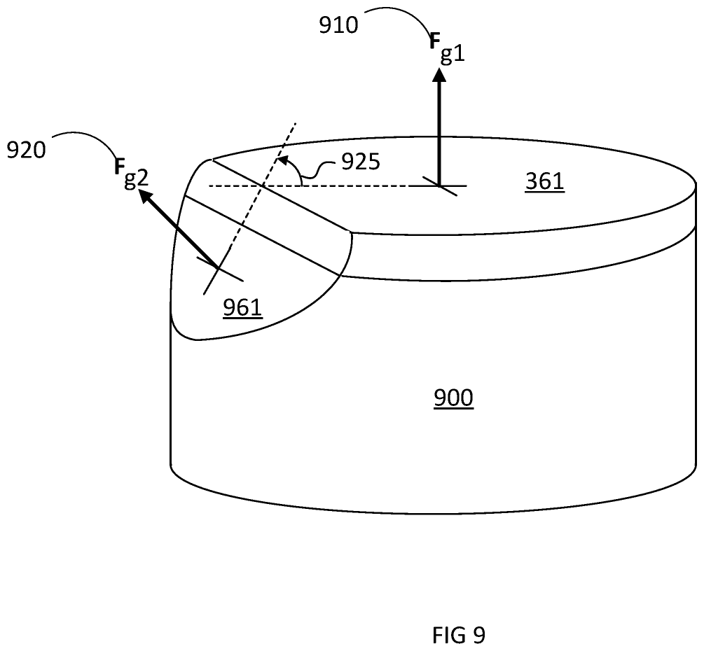

FIG. 8 illustrates a perspective view of cutter 60 engaging a portion of a formation substrate 500, according to some embodiments. In a dynamic model of the bit-rock interaction, the net local force exerted by cutter 60 onto formation substrate 500 may be divided into three mutually orthogonal components, namely: a drag force or contact force (Fc) 810, a penetration force (Fp) 820, and a side force (Fs) 830. Note that the three forces Fc 810, Fp 820, and Fs 830 are naturally defined within a cutter frame with axes X_{c}, Y_{c}, Z_{c} with origin fixed on the cutter.

In some embodiments, forces F_{c} 810, Fₚ 820, and Fₛ 830 may be modeled mathematically as:

$${F}_{c} = ko μξσ {S}^{α} {H}^{γ} ; H = \frac{A}{S} \\ {F}_{p} = v \cdot {F}_{c} tan ( β + ϕ ) ; \\ {F}_{s} = κ \cdot {F}_{c} ; \qquad ( 29 )$$

where kₒ is a coefficient used to calibrate the force, κ is a function of side rake angle, μ is a coefficient related to the back rake angle, ξ is a coefficient related to side rake angle, σ is the rock compressive strength, H is the equivalent cutting height, with A being the cutting area, and S is the arc length of the cutting area. Accordingly, S may be defined as the arc length described by cutter 60 while effectively removing material from the formation substrate (e.g., with cutting depth δ≠0). β is the back rake angle, φ is the cutter-rock friction angle, and α, ν, γ are pre-selected coefficients. Coefficients kₒ, μ, ξ, σ, β, and φ, cutting surface A, and arc length S may be collectively referred to as bit-rock interaction parameters. Accordingly, Eqs. 29 illustrate a step for determining a local force and an initial force (e.g., through forces Fc, Fp, and Fs, and Eqs. 2-4) on drill bit model 100 based on at least one bit-rock interaction parameter.

Eqs. 29 indicate a dependency of the dynamic drilling conditions on factors associated with the geometry of drill bit model 100 and also with material parameters of the formation substrate (Young Modulus, shear stress, and the like).

FIG. 9 illustrates a perspective view of a gage cutter 900 for drill bit model 100, according to some embodiments. Gage cutter 900 includes cutting face 361 and a contact face 961 formed at an angle 925 from each other. Upon bit-rock interaction, two forces may be defined: F_{g1} 910, projecting normally to cutting face 361, and F_{g2}, projecting normally to contact face 961. In some embodiments, forces F_{g1} 910, and F_{g2} 920 may be defined by the following expressions

F_{g1}=k_{d}·σ·A_{d}+k_{c}·σ·A_{c};

F_{g2}=k_{ad}·k_{d}·σ·A_{d}+k_{ac}·k_{c}·σ·A_{c};

F_{f1}=μ₁·F_{g1};

F_{f2}=μ₂·F_{g2}; (30)

where A_{d} is a drag area measured in cutting face 361 and A_{c} is a contact area between gage cutter 900 and a formation substrate, measured in the contact face 961, and k_{d}, k_{ad} (drag), k_{c}, and kₐ (contact) are pre-selected coefficients (e.g., bit-rock interaction parameters, as well as A_{d} and A_{c}). Some embodiments include modifying design parameters of drill bit model 100 and of gage cutter 60g in view of forces F_{g1} and F_{g2} in Eq. 30 to substantially reduce or minimize torque forces on gage cutter 900 (e.g., torque M_{zh}). In some embodiments, this includes adjusting angle 925 in gage cutter 900 and the area size of cutting face 361 relative to that of contact face 961. Further, in some embodiments, modifying design parameters of drill bit model 100 may include adjusting back rake angle 366-1 and/or side rake angle 366-3, of gage cutter 900 in drill bit model 100.

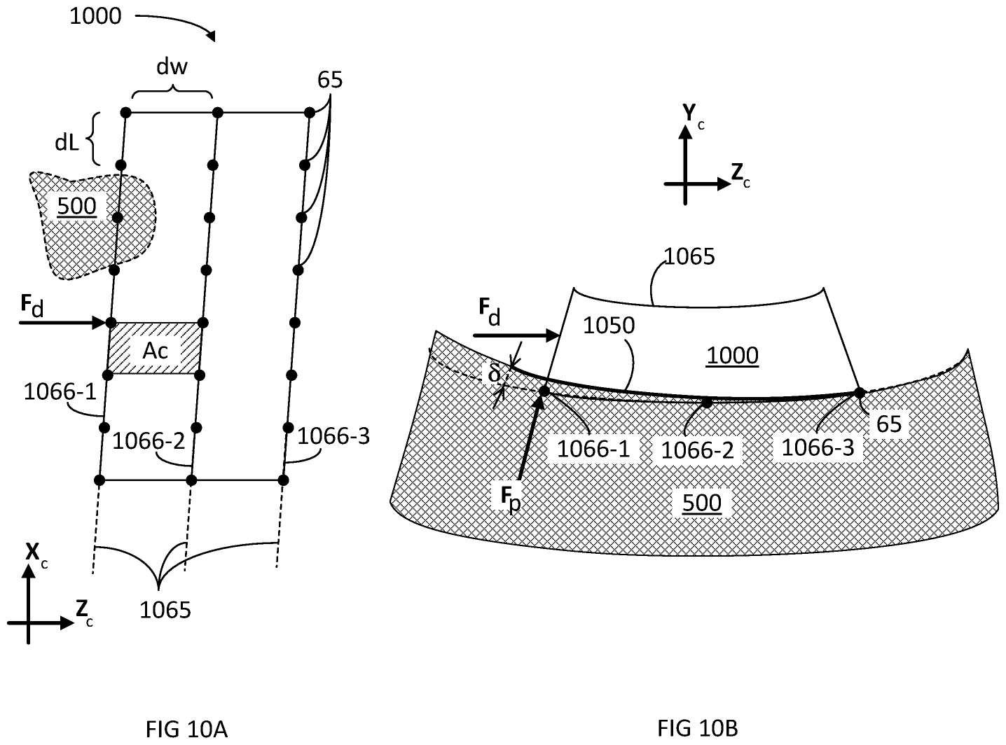

FIG. 10A illustrates a plan view of a mesh 1065 including cutlets 65 in a gage pad 1000 for determining rock-interaction forces with the formation substrate, according to some embodiments. Without loss of generality, the plan view is on the (X_{c}, Z_{c}) plane of gage pad 1000, which is assumed to move in the −Z_{c} direction, wherein formation substrate 500 is in the X_{X}, Z_{c} plane.

Mesh 1065 includes cutlets 65 arranged in a front line 1066-1, a middle line 1066-2, and a back line 1066-3 (hereinafter, collectively referred to as lines 1066). Mesh 1065 includes cutlets 65 separated sideways by a width dw, and longitudinally by a length dL.

FIG. 10B illustrates a side view of mesh 1065 including cutlets 65 in gage pad 1000 for determining rock-interaction local forces with the formation substrate, according to some embodiments. A cutting depth δ is formed along contact arc length 1050. A contact area A_{c} is defined as A_{c}=dL·dw, and a drag area, A_{c}, may be defined as A_{d}=δ·dL. Accordingly, drag force, F_{d}, and a penetration force, Fₚ, for a cutlet 65 in front line 1066-1 may be defined as

F_{d}=μ_{d}·σ·A_{d};

Fₚ=/μₚ·σ·A_{c}; (31)

where μ_{d}, tₚ and σ are material parameters for drill bit model 100 (e.g., PDC) and for the formation substrate, respectively.

Similarly, drag and contact forces in middle line 1066-2 and back line 1066-3 may be determined (adjusting for the penetration depth along contact arc length 1050). The total net local force on gage pad 1000 is then obtained by adding the local forces on each of cutlets 65.

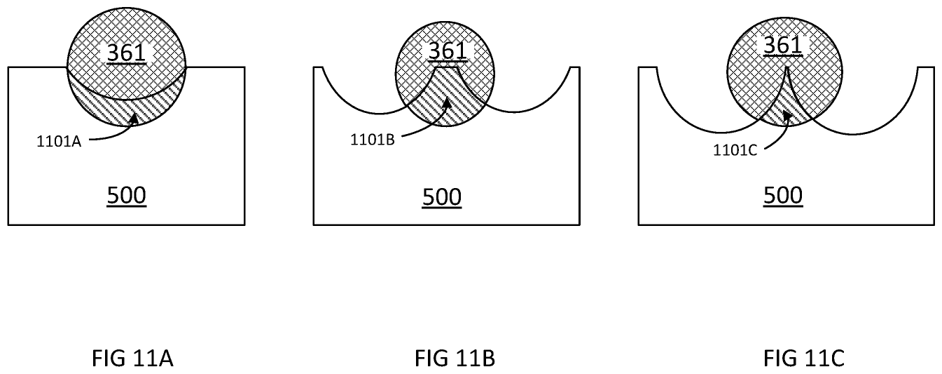

FIG. 11A illustrates a contact area 1101A in a first shape in a cutter-rock interaction, according to some embodiments.

FIG. 11B illustrates a contact area 1101B in a second shape in a cutter-rock interaction, according to some embodiments.

FIG. 11C illustrates a contact area 1101C in a third shape in a cutter-rock interaction, according to some embodiments.

While cutting face 361 may be the same in all instances, contact areas 1101A, 1101B, and 1101C (hereinafter collectively referred to as “contact areas 1101”), may be different from one another. Accordingly, different cutter-rock interaction models may be obtained for each of contact areas 1101. In general, contact areas 1101 may be used in method 700 to determine the 3D dimensions of the formation portions chipped by cutter 60 under different shape models. Accordingly, method 700 may include integrating the calculations of the formation portion over the depth profile, δ, for each of contact areas 1101.

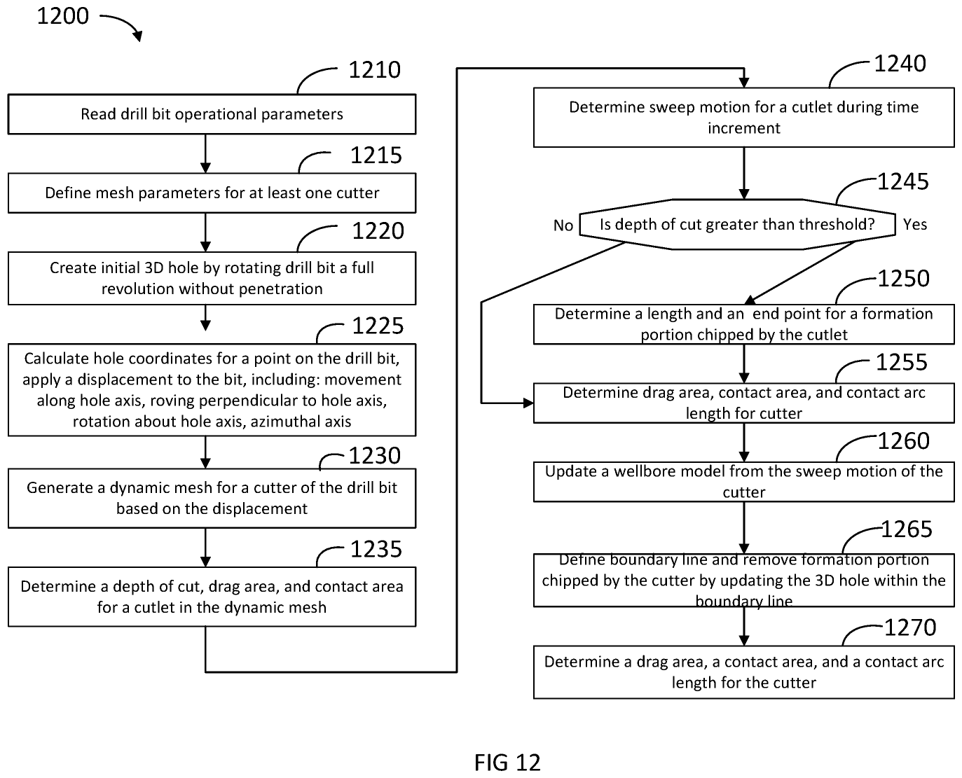

FIG. 12 illustrates a flowchart including steps in a method 1200 for modeling a bit-rock interaction, according to some embodiments. The bit-rock interaction may include a drill bit barreling through a wellbore, thus chipping away multiple formation portions after engagement with multiple cutters, according to some embodiments (e.g., drill bit model 100, formation portion 600, and cutters 60). For at least some of the steps in method 1200, a hole coordinate system fixed relative to the wellbore may be chosen in any suitable coordinate format, as described above (e.g., Cartesian: Xₕ, Yₕ, Zₕ, cylindrical: Rₕ, θₕ, Zₕ, polar: Rₕ, θₕ, φₕ, and the like).

At least some of the steps in method 1200 may be performed by a computer having a processor executing commands stored in a memory of the computer. Further, steps as disclosed in method 1200 may include retrieving, editing, and/or storing files in a database that is part of, or is communicably coupled to, the computer, using, a network communications module. The database may include any one of formation substrate data, computer-aided design data files (e.g., 3D models of drill bit model 100 and components) and the like. Methods consistent with the present disclosure may include at least some, but not all of the steps illustrated in method 1200, performed in a different sequence. Furthermore, methods consistent with the present disclosure may include at least two or more steps as in method 1200 performed overlapping in time, or almost simultaneously.

Step 1210 includes reading drill bit operational parameters. In some embodiments, step 1210 may include reading geometric information associated with a drill bit, for example, capturing a computer aided design (CAD) of a drill bit. Accordingly, step 1210 may include retrieving, from a CAD model, parameters such as a back rake angle, a side-rake angle, a profile angle, a position, and size for at least one of the cutters in a drill bit. In some embodiments, step 1210 may include reading gauge pad geometry such as pad length, pad width and pad spiral angle. In some embodiments, step 1210 may include reading geometries of depth of cut controller, such as location and diameter of MDR (Modified Diamond Reinforcement), location and diameter and length of impact arrestors. In some embodiments, step 1210 may include reading rock mechanical properties such compressive strength. In some embodiments, step 1210 may include reading bit rotational speed, bit penetration speed, bit steer rate and walk rate, bit lateral movement, as well as weight on bit and torque on bit.

Step 1215 includes defining mesh parameters for at least one cutter in the drill bit. Accordingly, step 1215 may include selecting at least a cutlet in the cutter, to perform the model. Step 1220 includes creating an initial 3D hole by rotating the drill bit a full revolution, without penetration.

Step 1225 includes calculating hole coordinates for a point on the drill bit, and applying a displacement to the drill bit. The displacement may be a small (e.g., infinitesimal) displacement in any arbitrary direction. In some embodiments, step 1225 includes incorporating in the displacement an axial movement along the hole axis (Zₕ), a lateral movement perpendicular to the hole axis in Xₕ and or in Yₕ, a rotation about the hole axis (Zₕ), and a rotation about an azimuthal axis (e.g., φₕ, cf. FIG. 2B).

In some embodiments, step 1225 includes providing a sequence of drill bit motions for a time interval dt as dθ=ω_{b} dt around it axis Z_{b}. Moving the drill bit a distance dz along Z_{b}. Step 1225 may further include moving the drill bit a distance, dx along axis Xₕ; rotating the bit an angle dβ around hole axis Yₕ and moving the drill bit a distance dy along axis Yₕ. Further, in some embodiments step 1225 may include rotating the drill bit an angle dφ around axis Xₕ. Furthermore, step 1225 may include determining at least three rotation matrices to apply the displacement to the drill bit.

Step 1230 includes generating a dynamic mesh for a cutter in the drill bit based on the displacement. In some embodiments, step 1230 includes re-defining a new mesh that tracks the new positions of the cutlets after the displacement of the drill bit. In some embodiments, the dynamic mesh may be determined by selecting integer amounts of radial displacements (e.g., dR) and angular displacements of the cutter (e.g., dθ).

Step 1235 includes determining a depth of cut, a drag area, and a contact area for a cutlet in the dynamic mesh. Step 1240 includes determining a sweep motion for a cutlet during the time increment. In some embodiments, step 1240 may include determining an arc of length of a cutting area (cf. S, Eq. 29). The sweep motion ends in a displaced position of the drill bit. Accordingly, the displaced position of the drill bit may be a portion (i.e., an infinitesimal portion) of the arc of length of the cutting area.

Step 1245 includes determining whether the depth of cut is greater than a pre-selected threshold. The threshold may include a “critical depth of cut” (CDOC) value. Step 1250 includes determining a length and an end point for a formation portion chipped by the cutlet when the depth of cut is greater than the preselected threshold.

Step 1255 includes determining a drag area, a contact area, and a contact arc length for the cutter. In some embodiments, step 1255 is performed also when the depth of cut is smaller than the pre-selected threshold according to step 1245. Step 1260 includes updating a wellbore from the sweep motion of the cutter. In some embodiments, the wellbore is a 3D hole stored in a CAD file for modeling the bit-rock interaction.

Step 1265 includes defining a boundary line and removing the formation portion chipped by the cutter by updating the 3D hole within the boundary line. In some embodiments, step 1265 may include obtaining a 3D model of the formation portion chipped by the cutter, and subtracting the 3D model from the hole. Further, in some embodiments step 165 may include obtaining 3D models for substrate portions chipped away by all, or almost all the cutters in the drill bit, and subtracting the aggregated volume of all the substrate portions from the formation, to update the 3D hole.

Step 1270 includes determining a drag area, a contact area, and a contact arc length for the cutter. In some embodiments, step 1270 includes adding the contact area and the contact arc length for all cutlets in the cutter.

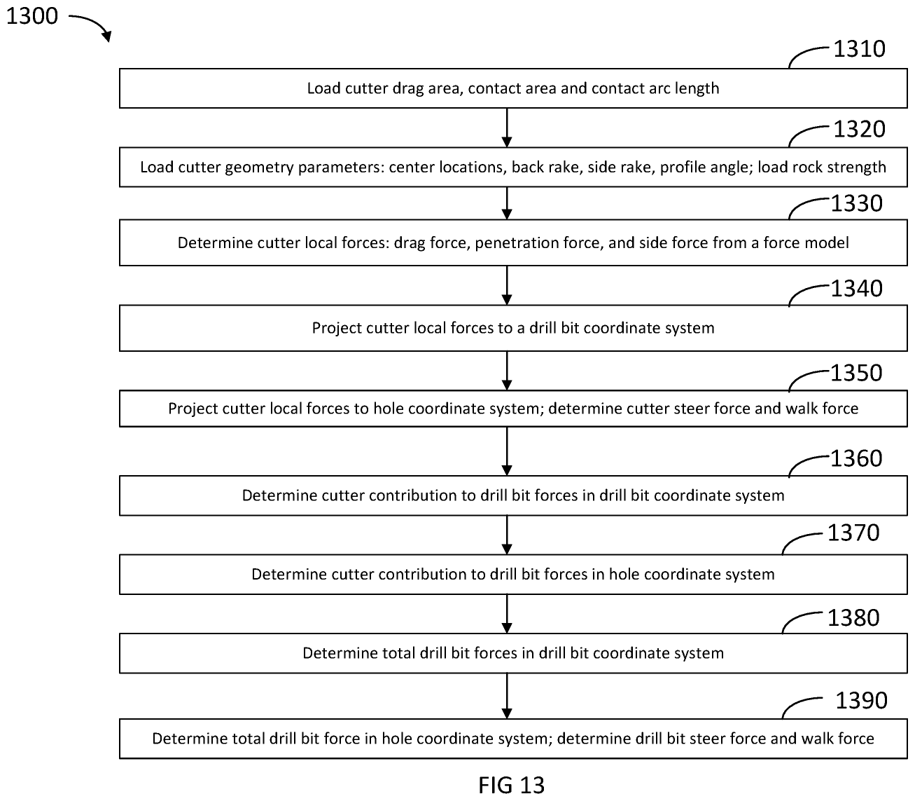

FIG. 13 illustrates a flowchart including steps in a method 1300 for determining a steer force and a walk force on a drill bit, according to some embodiments. The bit-rock interaction may include a drill bit barreling through a wellbore, thus chipping away a formation portion after engagement with multiple cutters, according to some embodiments (e.g., drill bit model 100, formation portion 600, and cutters 60). For at least some of the steps in method 1300, a hole coordinate system fixed relative to the wellbore may be chosen in any suitable coordinate format, as described above (e.g., Cartesian: Xₕ, Yₕ, Zₕ, cylindrical: Rₕ, θₕ, Zₕ, polar: Rₕ, θₕ, φₕ, and the like).

At least some of the steps in method 1300 may be performed by a computer having a processor executing commands stored in a memory of the computer. Further, steps as disclosed in method 1300 may include retrieving, editing, and/or storing files in a database that is part of, or is communicably coupled to, the computer, using, inter-alia, a network communications module. The database may include any one of formation substrate data, computer-aided design data files (e.g., 3D models of drill bit model 100 and components) and the like. Methods consistent with the present disclosure may include at least some, but not all of the steps illustrated in method 1300, performed in a different sequence. Furthermore, methods consistent with the present disclosure may include at least two or more steps as in method 1300 performed overlapping in time, or almost simultaneously.

Step 1310 includes loading the cutter drag area, the contact area, and the contact arc length. Step 1320 includes loading the cutter geometry parameters such as center locations, back rake angle, side rake angle, and profile angle. In some embodiments, step 1320 includes also loading a rock strength.

Step 1330 includes determining cutter local forces such as drag force, penetration force, and side force, from a force model. Step 1340 includes projecting the cutter local forces into a drill bit coordinate system. Step 1350 includes projecting cutter local forces to hole coordinate system, and determining the cutter steer force and walk force.

Step 1360 includes determining the cutter contribution to drill bit local forces in the drill bit coordinate system. Step 1370 includes determining the cutter contribution to drill bit local forces in the hole coordinate system. Step 1380 includes determining a total drill bit local force in the drill bit coordinate system,
F_{b}={F_{xb}, F_{yb}, F_{zb}, M_{xb}, M_{yb}, M_{zb}}

Step 1390 includes determining the total drill bit local force
Fₕ={Fₓₕ, F_{yh}, F_{zh}, Mₓₕ, M_{yh}, M_{zh}}

In some embodiments the BHA includes a controller having memory storing instructions and a processor configured to execute the instructions in the memory to cause the controller to adjust at least one parameter for a drill bit in a wellbore based on the instructions. The instructions stored in the memory may be obtained according to methods as disclosed herein. Accordingly, the memory may store a bit-rock interaction model obtained by performing the step retrieving at least one parameter for a drill bit, the at least one parameter including a geometrical factor of a cutter in the drill bit. Further, the bit-rock interaction model may be obtained by dynamically adjusting a mesh of points representing cutlets in a cutter to a displaced position of the drill bit, updating a shape of a wellbore formed by the displacement of the drill bit to the displaced position of the drill bit, and determining a local force and an initial force on the drill bit based on the shape of the wellbore. In some embodiments, the bit-rock interaction model may include determining at least one damping coefficient for the bit-rock interaction model based on the local force and the initial force on the drill bit.

In some embodiments, step 1390 may include adjusting the at least one parameter (e.g., steerability, walk angle, cutting ability, drilling efficiency, WOB, TOB, and the like) for the drill bit according to a drilling operation in the wellbore. In some embodiments, step 1390 may include improving at least one of a drilling efficiency in the wellbore or a drill bit steerability.

In some embodiments, step 1390 may further include storing at least one parameter in a controller for a bottom hole assembly to control a drill string dynamics in the drilling operation. In some embodiments, step 1390 may include fabricating a drill bit having a geometry that includes at least one parameter as described above.

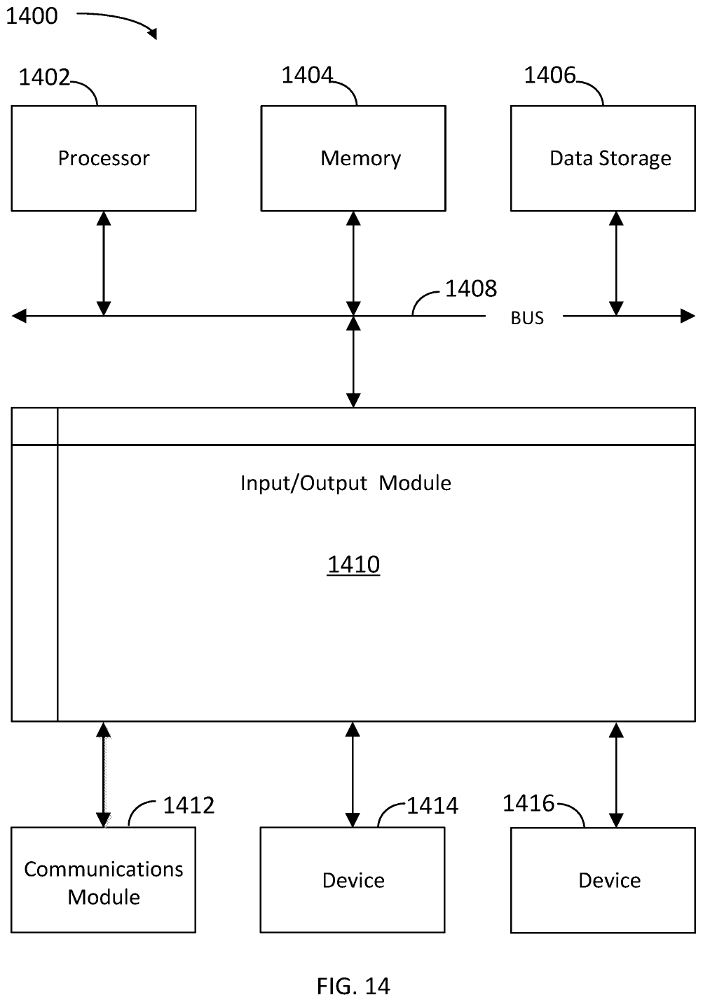

FIG. 14 is a block diagram illustrating an example computer system 1400 with which the methods of FIGS. 7, 12 and 13 can be implemented. In certain aspects, the computer system 1400 may be implemented using hardware or a combination of software and hardware, either in a dedicated server, or integrated into another entity, or distributed across multiple entities.

Computer system 1400 includes a bus 1408 or other communication mechanism for communicating information, and a processor 1402 coupled with bus 1408 for processing information. By way of example, the computer system 1400 may be implemented with one or more processors 1402. Processor 1402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1400 can include, in addition to hardware, code that creates an execution environment for the computer program in question, e.g., code that constitutes processor firmware, a protocol stack, a database management system, an operating system, or a combination of one or more of them stored in an included memory 1404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1408 for storing information and instructions to be executed by processor 1402. The processor 1402 and the memory 1404 can be supplemented by, or incorporated in, special purpose logic circuitry.

The instructions may be stored in the memory 1404 and implemented in one or more computer program products, i.e., one or more modules of computer program instructions encoded on a computer readable medium for execution by, or to control the operation of, the computer system 1400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1404 may also be used for storing temporary variable or other intermediate information during execution of instructions to be executed by processor 1402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1400 further includes a data storage device 1406 such as a magnetic disk or optical disk, coupled to bus 1408 for storing information and instructions. Computer system 1400 may be coupled via input/output module 1410 to various devices. Input/output module 1410 can be any input/output module. Exemplary input/output modules 1410 include data ports such as USB ports. The input/output module 1410 is configured to connect to a communications module 1412. Exemplary communications modules 1412 include networking interface cards, such as Ethernet cards and modems. In certain aspects, input/output module 1410 is configured to connect to one or more devices, such as an input device 1414 and/or an output device 1416. Exemplary input devices 1414 include a keyboard and a pointing device, e.g., a mouse or a trackball, by which a user can provide input to the computer system 1400. Other kinds of input devices 1414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1416 include display devices, such as a LCD (liquid crystal display) monitor, for displaying information to the user.

According to one aspect of the present disclosure, methods 1200 and 1300 can be implemented using a computer system 1400 in response to processor 1402 executing one or more sequences of one or more instructions contained in memory 1404. Such instructions may be read into memory 1404 from another machine-readable medium, such as data storage device 1406. Execution of the sequences of instructions contained in main memory 1404 causes processor 1402 to perform the process steps described herein. One or more processors in a multi-processing arrangement may also be employed to execute the sequences of instructions contained in memory 1404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1400 can include clients and servers. A client and server are generally remote from each other and typically interact through a communication network. The relationship of client and server arises by virtue of computer programs running on the respective computers and having a client-server relationship to each other. Computer system 1400 can be, for example, and without limitation, a desktop computer, laptop computer, or tablet computer. Computer system 1400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1402 for execution. Such a medium may take many forms, including, but not limited to, non-volatile media, volatile media, and transmission media. Non-volatile media include, for example, optical or magnetic disks, such as data storage device 1406. Volatile media include dynamic memory, such as memory 1404. Transmission media include coaxial cables, copper wire, and fiber optics, including the wires that include bus 1408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

Embodiments disclosed herein include:

A. A computer-implemented method including selecting a parameter for a drill bit model, the parameter including a geometrical factor of a cutter represented in the drill bit model, dynamically adjusting the drill bit model to a displaced position, updating a shape of a wellbore model formed by the displaced position of the drill bit model, determining a local force and an initial force on the drill bit model based on the shape of the wellbore model and the parameter for the drill bit model, determining, by a processor, at least one coefficient for a bit matrix based on the local force and the initial force on the drill bit model, and storing the bit matrix in a memory, wherein the bit matrix is indicative of an interaction between a drill bit represented by the drill bit model and a formation substrate.

B. A system, including a memory configured to store a bit matrix including at least one coefficient determined based at least in part on a bit-rock interaction model to reflect a displaced position of a drill bit model and local and initial forces on the drill bit model determined from an updated shape of a wellbore model formed by the displaced position of the drill bit model, and a controller configured to utilize the bit matrix to steer a drill bit in a wellbore, the drill bit represented by the drill bit model.

C. A device including a memory configured to store a bit matrix including at least one coefficient determined based at least in part on local and initial forces on a drill bit model caused by a shape of a wellbore model, the shape of the wellbore model being formed by displaced positions of the drill bit model, and a processor configured to utilize the bit matrix for a dynamic simulation of a wellbore drilling operation.

Each of embodiments A, B, and C may have one or more of the following additional elements in any combination. Element 1, including selecting a speed for the drill bit model based on a desired orientation of the wellbore model. Element 2, wherein the memory is part of a controller for a bottom hole assembly, the method further including controlling a drill string dynamics in a drilling operation based at least in part on the bit matrix. Element 3, further including fabricating the drill bit based at least in part on a bit-rock interaction model that includes the bit matrix. Element 4, wherein determining, by the processor, the at least one coefficient for the bit matrix includes determining a walk force on the drill bit. Element 5, including determining the displaced position based at least in part on a speed of the drill bit model in a first direction in the wellbore model and an angular speed of the drill bit model about a second direction in the wellbore model. Element 6, wherein updating the shape of the wellbore model includes determining one of a depth of cut, a drag area, or a contact area for a cutting surface in the cutter represented in the drill bit model. Element 7, wherein determining the local force on the drill bit model based on the shape of the wellbore model includes determining at least one of a drag force, a steer force, and walk force on the drill bit model. Element 8, including determining a drilling efficiency from at least one coefficient in the bit matrix.

Element 9, wherein the controller is further configured to control drill string dynamics of a drilling operation based on the bit matrix. Element 10, wherein the controller is further configured to determine a torque on the drill bit based on a walk force parameter and a bit steerability parameter from the bit matrix, and steer the drill bit based at least in part on the torque. Element 11, wherein the controller is further configured to determine a speed of the drill bit in a first direction in the wellbore and an angular speed about a second direction in the wellbore, and to steer the drill bit based at least in part on the speed and the bit matrix. Element 12, wherein the controller is further configured to select a force and a torque on the drill bit to increase a size of a formation portion chipped away by a cutter in the drill bit, and to steer the drill bit based at least in part on the force, the torque, and the bit matrix. Element 13, wherein the controller is further configured to select a force and a torque on the drill bit to direct the drill bit away from a hardened formation substrate, and to steer the drill bit based at least in part on the force, torque, and the bit matrix.

Element 14, wherein the processor is further configured to simulate drill string dynamics in the dynamic simulation of the wellbore drilling operation based on at least in part on the bit matrix. Element 15, wherein processor is further configured to determine a simulated torque on a drill bit represented by the drill bit model in the dynamic simulation based on a walk force parameter, a bit steerability parameter from the bit matrix, and a speed of the drill bit represented by the drill bit mode. Element 16, wherein the processor is further configured to determine a speed of the drill bit model in the dynamic simulation in a first direction in the wellbore drilling operation and an angular speed about a second direction in the wellbore drilling operation based on a simulated force determined by the bit matrix and the speed of the drill bit model. Element 17, wherein the processor is further configured to select a force and a torque on the drill bit model in the dynamic simulation to increase a size of a formation portion chipped away by a cutter in the drill bit model, based on the bit matrix and a speed of the drill bit model in the dynamic simulation.

It is recognized that the various embodiments herein directed to computer control and artificial neural networks, including various blocks, modules, elements, components, methods, and algorithms, can be implemented using computer hardware, software, combinations thereof, and the like. To illustrate this interchangeability of hardware and software, various illustrative blocks, modules, elements, components, methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the scope of the embodiments expressly described.

Computer hardware used to implement the various illustrative blocks, modules, elements, components, methods, and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM, and flash EPROM.

The exemplary embodiments described herein is well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of X, Y, and Z” or “at least one of X, Y, or Z” each refer to only X, only Y, or only Z; any combination of X, Y, and Z; and/or at least one of each of X, Y, and Z.

The invention claimed is:

1. A computer-implemented method comprising:
selecting a parameter for a drill bit model, the parameter including a geometrical factor of a cutter represented in the drill bit model;
dynamically adjusting the drill bit model to a displaced position;
updating a shape of a wellbore model formed by the displaced position of the drill bit model;
determining a local force and an initial force on the drill bit model based on the shape of the wellbore model and the parameter for the drill bit model;
determining, by a processor, at least one coefficient for a bit matrix based on the local force and the initial force on the drill bit model; and
storing the bit matrix in a memory, wherein the bit matrix is indicative of an interaction between a drill bit represented by the drill bit model and a formation substrate.

2. The computer-implemented method of claim 1, further comprising:
selecting a speed for the drill bit model based on a desired orientation of the wellbore model.

3. The computer-implemented method of claim 1, wherein the memory is part of a controller for a bottom hole assembly, the method further comprising controlling a drill string dynamics in a drilling operation based at least in part on the bit matrix.

4. The computer-implemented method of claim 1, further comprising fabricating the drill bit based at least in part on a bit-rock interaction model that includes the bit matrix.

5. The computer-implemented method of claim 1, wherein determining, by the processor, the at least one coefficient for the bit matrix comprises:
determining a walk force on the drill bit.

6. The computer-implemented method of claim 1, further comprising determining the displaced position based at least in part on a speed of the drill bit model in a first direction in the wellbore model and an angular speed of the drill bit model about a second direction in the wellbore model.

7. The computer-implemented method of claim 1, wherein updating the shape of the wellbore model comprises determining one of a depth of cut, a drag area, or a contact area for a cutting surface in the cutter represented in the drill bit model.

8. The computer-implemented method of claim 1, wherein determining the local force on the drill bit model based on the shape of the wellbore model comprises determining at least one of a drag force, a steer force, and walk force on the drill bit model.

9. The computer-implemented method of claim 1, further comprising determining a drilling efficiency from at least one coefficient in the bit matrix.

10. A system, comprising:
a memory configured to store a bit matrix comprising at least one coefficient determined based at least in part on a bit-rock interaction model to reflect a displaced position of a drill bit model and local and initial forces on the drill bit model determined from an updated shape of a wellbore model formed by the displaced position of the drill bit model; and
a controller configured to:
utilize the bit matrix to steer a drill bit in a wellbore, the drill bit represented by the drill bit model.

11. The system of claim 10, wherein the controller is further configured to:
control drill string dynamics of a drilling operation based on the bit matrix.

12. The system of claim 10, wherein the controller is further configured to:
determine a torque on the drill bit based on a walk force parameter and a bit steerability parameter from the bit matrix; and
steer the drill bit based at least in part on the torque.

13. The system of claim 10, wherein the controller is further configured to:
determine a speed of the drill bit in a first direction in the wellbore and an angular speed about a second direction in the wellbore; and
steer the drill bit based at least in part on the speed and the bit matrix.

14. The system of claim 10, wherein the controller is further configured to:
select a force and a torque on the drill bit to increase a size of a formation portion chipped away by a cutter in the drill bit; and
steer the drill bit based at least in part on the force, the torque, and the bit matrix.

15. The system of claim 10, wherein the controller is further configured to:
select a force and a torque on the drill bit to direct the drill bit away from a hardened formation substrate; and
steer the drill bit based at least in part on the force, torque, and the bit matrix.

16. A device comprising:
a memory configured to store a bit matrix comprising at least one coefficient determined based at least in part on local and initial forces on a drill bit model caused by a shape of a wellbore model, the shape of the wellbore model being formed by displaced positions of the drill bit model; and
a processor configured to:
utilize the bit matrix for a dynamic simulation of a wellbore drilling operation.

17. The device of claim 16, wherein the processor is further configured to:
simulate drill string dynamics in the dynamic simulation of the wellbore drilling operation based on at least in part on the bit matrix.

18. The device of claim 16, wherein processor is further configured to:
determine a simulated torque on a drill bit represented by the drill bit model in the dynamic simulation based on a walk force parameter, a bit steerability parameter from the bit matrix, and a speed of the drill bit represented by the drill bit model.

19. The device of claim 16, wherein the processor is further configured to:
determine a speed of the drill bit model in the dynamic simulation in a first direction in the wellbore drilling operation and an angular speed about a second direction in the wellbore drilling operation based on a simulated force determined by the bit matrix and the speed of the drill bit model.

20. The device of claim 16, wherein the processor is further configured to:
select a force and a torque on the drill bit model in the dynamic simulation to increase a size of a formation portion chipped away by a cutter in the drill bit model, based on the bit matrix and a speed of the drill bit model in the dynamic simulation.
